(19) United States
(12) Patent Application Publication
(10) Pub. No.: US 2025/0110460 A1
(43) Pub. Date: Apr. 3, 2025

(54) BUILDING MANAGEMENT SYSTEM WITH AUGMENTED REALITY COMMAND CENTER

(71) Applicant: Tyco Fire & Security GmbH, Neuhausen am Rheinfall (CH)

(72) Inventors: Lipphei Adam, Nolensville, TN (US); Miguel Galvez, Westford, MA (US); Michael Tenbrock, Dachsen (CH); Trent M. Swanson, Wellington, FL (US)

(21) Appl. No.: 18/896,720

(22) Filed: Sep. 25, 2024

Related U.S. Application Data
(60) Provisional application No. 63/594,269, filed on Oct. 30, 2023.
(60) Provisional application No. 63/541,539, filed on Sep. 29, 2023.

(51) Int. Cl. G05B 19/042

(52) U.S. Cl. CPC G05B 19/042; G05B 2219/25011

(57) ABSTRACT

A building system including one or more storage devices storing instructions thereon that, when executed by one or more processors, cause the processors to receive building information associated with one or more entities of the building, the one or more entities comprising at least one of locations, events, assets, or people associated with the building, categorize the building information into a first set of the building information and a second set of the building information different from the first set, the first and second sets of the building information extracted and/or derived from the building information, and generate a distributed command center for monitoring and/or responding to events in or associated with the building, the distributed command center comprising a plurality of command center interfaces to be provided to a plurality of users on a plurality of devices.

### CROSS-REFERENCE TO RELATED PATENT APPLICATIONS

This application claims priority to and the benefit of U.S. Provisional Patent Application Nos. 63/541,539, filed Sep. 29, 2023, titled “Building Management System with Augmented Reality Command Center, and 63/594,269, filed Oct. 30, 2023, titled “Systems and Methods for Learning and Utilizing Occupant Tolerance in Demand Response,” both of which are incorporated by reference herein in their entireties.

### BACKGROUND

This application relates generally to a building system of a building. This application relates more particularly to systems for managing and processing data of the building system.

A building may aggregate and store building data received from building equipment and/or other data sources. Specifically, the building system may contain a variety separate building subsystems, such as security subsystems, HVAC subsystems, lighting subsystems, vision subsystems, security subsystems, etc. The present disclosure relates generally to a building management system with an command center that displays this information.

### SUMMARY

One implementation is directed towards a building system. The building system includes one or more storage devices storing instructions thereon that, when executed by one or more processors, cause the processors to receive building information associated with one or more entities of the building, the one or more entities including at least one of locations, events, assets, or people associated with the building, categorize the building information into a first set of the building information and a second set of the building information different from the first set, the first and second sets of the building information extracted and/or derived from the building information, and generate a distributed command center for monitoring and/or responding to events in or associated with the building, the distributed command center comprising a plurality of command center interfaces to be provided to a plurality of users on a plurality of devices, the plurality of devices including a first device of a first user and a second device of a second user. In some embodiments, generating the distributed command center includes generating a first command center interface comprising the first set of building information to be provided to the first user based on at least one of a first role or a first set of permissions associated with the first user, generating a second command center interface comprising the second set of building information to be provided to the second user based on at least one of a second role or a second set of permissions associated with the second user, and transmitting the first command center interface to the first device of the first user and the second command center interface to the second device of the second user.

In some embodiments, the instructions cause the one or more processors to receive credentials of the plurality of users, compare the credentials to a stored building operation personnel database, determine a role of the plurality of users based on a comparison between the credentials and the stored building operation personnel database, categorize the plurality of users based on the determined role received from the stored building operation personnel database, determine a correlation between the categorized building information and the categorized plurality of users by comparing the description tags and the determined role, and present the building information to the plurality of users based on the determined correlation.

In some embodiments, the instructions cause the one or more processors to receive information regarding the plurality of users, receive a role of the plurality of users from a stored building operation personnel database, determine if the role of the plurality of users is the same as an associated role associated with the building information, and (i) present the building information to a user of the plurality of users on the one or more display devices if the role of the user is the same as the associated role, or (ii) restrict access to the building information to the user if the role of the user is not the same as the associated role.

In some embodiments, the one or more display devices are augmented reality devices or virtual reality devices.

In some embodiments, the building information is presented as a graphical user interface. In some embodiments, the graphical user interface further includes a user-selectable option to adjust an operation of building equipment based on the building information presented.

In some embodiments, the one or more display devices are implemented within a virtual or physical command center. In some embodiments, the instructions further cause the processor to store the received building information in a digital twin graph. In some embodiments, an artificial intelligence agent executes a machine learning algorithm based on the building information stored in the digital twin graph to categorize the building information.

Various embodiments are directed to methods and computer-readable media having features similar to those described above.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a building data platform including an edge platform, a cloud platform, and a twin manager, according to an exemplary embodiment.

FIG. 2 is a graph projection of the twin manager of FIG. 1 including application programming interface (API) data, capability data, policy data, and services, according to an exemplary embodiment.

FIG. 3 is another graph projection of the twin manager of FIG. 1 including application programming interface (API) data, capability data, policy data, and services, according to an exemplary embodiment.

FIG. 4 is a graph projection of the twin manager of FIG. 1 including equipment and capability data for the equipment, according to an exemplary embodiment.

FIG. 5 is a block diagram of a system for managing a digital twin where an artificial intelligence agent can be executed to infer information for an entity of a graph, according to an exemplary embodiment.

FIG. 6 is a flow diagram of a process for executing an artificial intelligence agent to receive and present building information to building operation personnel, according to an exemplary embodiment.

FIG. 7 is a flow diagram of a process for categorizing building operation personnel into a determined role, according to an exemplary embodiment.

FIG. 8 is a flow diagram of a process for determining which building operation personnel receives access to building information, according to an exemplary embodiment.

FIGS. 9, 10, 11, 12, and 13 are snapshots of custom dashboards displayed to building operation personnel based on the determined role of the operation personnel, according to some embodiments.

### DETAILED DESCRIPTION

### Overview

Command centers are a method for managing building operation information. In some embodiments, the command center may include displaying a large amount of building information/data on one or more screens in a room, such that the entire room may access and view the screens.

The systems and methods described herein provide multiple technical benefits. Specifically, the systems and methods described herein provide an improved command center which categorizes building information into relevant areas so that they may be displayed to relevant building operation personnel. In some embodiments, the building management system is configured to tag building information with relevant tags and to display the building information to the relevant proper building operation personnel, according to correlations determined between the tagged information and the description of the building personnel. In other embodiments, an artificial intelligence agent executes a process to determine the relevant building information being displayed to each building operation personnel. Through the building management system, each building operation personnel is presented with a different command center display, based on the information that is determined to be relevant to them. In this regard, power consumption is mitigated by eliminating the need for the command center display that displays every piece of building information to everyone in a room. Specifically, the systems and methods may be more efficient by utilizing smaller, less resource intensive devices for displaying building information and may improve utilization of technical resources by allowing, in some instances, for devices (e.g., personal computer, smart phone, tablet, etc.) the user would otherwise be using for other purposes to be used as the display device. The security of the building information is also improved because only the relevant building information is provided to each individual building operation personnel.

In some implementations, various aspects of the features described herein (e.g., artificial intelligence and/or machine learning-related features) may be implemented using and/or used in combination with features described in U.S. Provisional Patent Application No. 63/594,269, filed Oct. 30, 2023, which is incorporated herein by reference in its entirety.

Referring generally to the FIGURES, systems and methods for digital twins of a building are shown, according to various exemplary embodiments. A digital twin can be a virtual representing of a building and/or an entity of the building (e.g., space, piece of equipment, occupant, etc.). Furthermore, the digital twin can represent a service performed in a building, e.g., facility management, equipment maintenance, etc.

In some embodiments, the digital twin can include an information data store and a connector. The information data store can store the information describing the entity that the digital twin operates for (e.g., attributes of the entity, measurements associated with the entity, control points or commands of the entity, etc.). In some embodiments, the data store can be a graph including various nodes and edges. The connector can be a software component the provides telemetry from the entity (e.g., physical device) to the information store. Furthermore, the digital twin can include artificial intelligence (AI), e.g., an AI agent. The AI can be one or more machine learning algorithms and/or models that operate based on information of the information data store and outputs information.

In some embodiments, one or more processors may execute processes to determine correlations between building information received as a result of an event and the building operation personnel. The building information could be activated sensors in building entries, energy consumption levels, air quality changes, etc. In some embodiments, the correlations may be determined based on tags assigned to the data relating to the building information and the building operation personnel. In some embodiments, the AI agent for the digital twin can call an AI service to determine the correlations between building information received as a result of an event and the building operation personnel in a data structure of the digital twin. In some embodiments, the AI agent can store received building information in a graph data store as a node in the graph data store related to an entity that the digital twin represents. In some embodiments, the AI agent can categorize the received building information and store the received building information in a categorized data store. In some embodiments, the digital twin can operate against the building information, e.g., provide control algorithms to qualified building operation personnel for operating equipment of a building based on received data points of the building.

Furthermore, the one or more processors can determine which building operation personnel are allowed to access certain building information based on the role of the building personnel. In some embodiments, the processors determine which personnel have access based on a correlation determined between assigned role tags and assigned tags to the building information. In some embodiments, the AI agent can call an AI service to determine which building operation personnel are allowed to access certain building information based on the role of the building personnel. For example, the digital twin may receive information from a security camera, determine that the information should only be accessible to those with the role of security personnel, determine which building operation personnel are security personnel, and allow the determined security personnel access to the information received from the security camera. In another example, the digital twin may receive information regarding a change in energy consumption levels, determine that the information should be accessible to building personnel with a role relating to energy (energy manager, energy consultant, solar panel installer, sustainability manager, etc.), and allow the determined security personnel access to the information received regarding energy consumption levels. In another example, the digital twin may receive information (e.g., temperature, humidity, light, window screens, etc. for an individual or defined group of people) regarding a specified subset of people associated with a building (e.g., a specific person, multiple persons associated with a certain desk, office, building room, etc.), determine that information should be accessible with a building role related personnel management, and allowing the determined personnel management users to access the information. In some embodiments, the AI agent may determine which building operation personnel have restricted access to the building information based on the role of the building operation personnel. The determination of which building operation personnel have access to certain information ensures that the most relevant building information is presented to the correct building operation personnel which allows the building operation personnel to manage the operation of the building more efficiently and effectively. By automatically distributing access of building operation information to building operation personnel at the time it is received, the information is directly presented on the correct devices and action can be taken immediately. In some embodiments, the role of the building operation personnel is determined by the AI agent based on a credential, which may be stored in a data store. The credential information could be an employee identification number, a security identification number, an employee department number, etc. In some embodiments, the AI agent may determine a role of the building operation personnel based on their credential information. In some embodiments, the AI agent can execute a comparison process to determine similarities between the role of the building operation personnel and the categorized building information. The comparison process could be a comparison of the role of the building operation personnel and the category of the building information, for example. In some embodiments, the AI agent may allow access to the building information to the correct building operation personnel, based on the results of the comparison. In some embodiments, the AI agent may restrict access to the building information to building operation personnel, if the comparison does not result in a sufficient correlation between the building information and the building operation personnel. The building information may be presented to building operation personnel on various display devices. In some embodiments, the building information is presented on augmented reality devices. In some embodiments, each building operation personnel is presented with a customized command center display on one or more display devices. In some embodiments, the display devices with customized displays are part of a physical or virtual command center. For example, the command center could be a physical command center in which personnel are physically located in one or more spaces of a building. As another example, the command center may be a virtual command center in which personnel may be located anywhere and receive the relevant information on devices where they are located. The display devices may allow the building operation personnel to alter building operations in response to the building information received. The building information may be configurable to be displayed on various display devices, so as no not limit access to the building information to one location or one device. The various aspects and embodiments disclosed herein are for purposes of illustration and are not intended to be limiting.

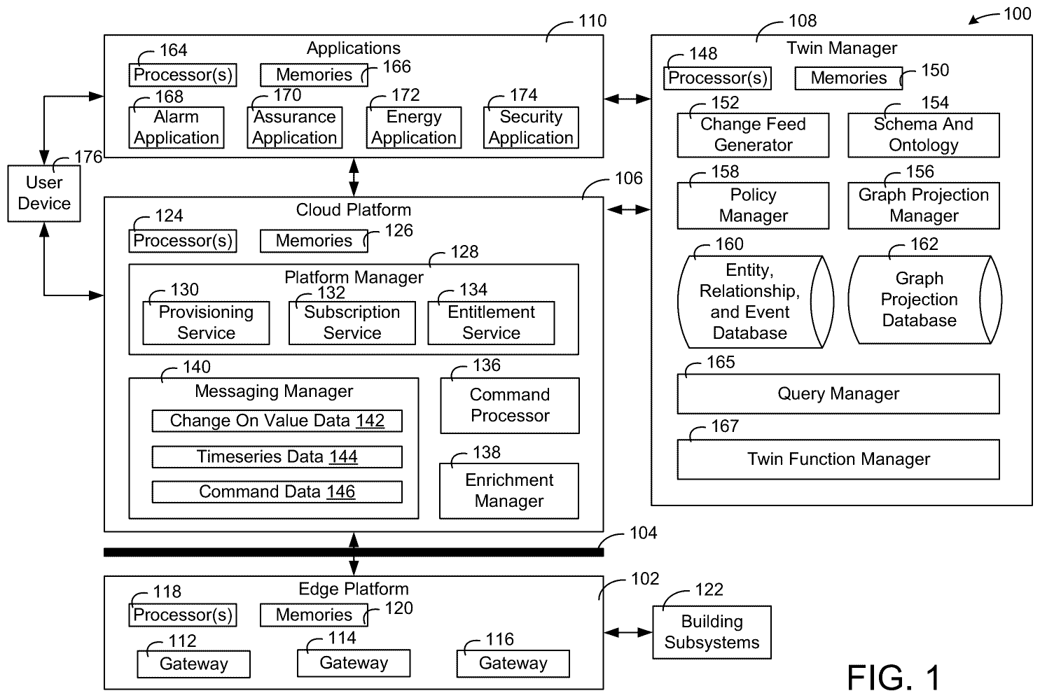

Referring now to FIG. 1, a building data platform 100 including an edge platform 102, a cloud platform 106, and a twin manager 108 are shown, according to an exemplary embodiment. The edge platform 102, the cloud platform 106, and the twin manager 108 can each be separate services deployed on the same or different computing systems. In some embodiments, the cloud platform 106 and the twin manager 108 are implemented in off premises computing systems, e.g., outside a building. The edge platform 102 can be implemented on-premises, e.g., within the building. However, any combination of on-premises and off-premises components of the building data platform 100 can be implemented.

The building data platform 100 includes applications 110. The applications 110 can be various applications that operate to manage the building subsystems 122. The applications 110 can be remote or on-premises applications (or a hybrid of both) that run on various computing systems. The applications 110 can include an alarm application 168 configured to manage alarms for the building subsystems 122. The applications 110 include an assurance application 170 that implements assurance services for the building subsystems 122. In some embodiments, the applications 110 include an energy application 172 configured to manage the energy usage of the building subsystems 122. The applications 110 include a security application 174 configured to manage security systems of the building.

In some embodiments, the applications 110 and/or the cloud platform 106 interacts with a user device 176. In some embodiments, a component or an entire application of the applications 110 runs on the user device 176. The user device 176 may be a laptop computer, a desktop computer, a smartphone, a tablet, and/or any other device with an input interface (e.g., touch screen, mouse, keyboard, etc.) and an output interface (e.g., a speaker, a display, etc.).

The applications 110, the twin manager 108, the cloud platform 106, and the edge platform 102 can be implemented on one or more computing systems, e.g., on processors and/or memory devices. For example, the edge platform 102 includes processor(s) 118 and memories 120, the cloud platform 106 includes processor(s) 124 and memories 126, the applications 110 include processor(s) 164 and memories 166, and the twin manager 108 includes processor(s) 148 and memories 150.

The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

The edge platform 102 can be configured to provide connection to the building subsystems 122. The edge platform 102 can receive messages from the building subsystems 122 and/or deliver messages to the building subsystems 122. The edge platform 102 includes one or multiple gateways, e.g., the gateways 112-116. The gateways 112-116 can act as a gateway between the cloud platform 106 and the building subsystems 122. The gateways 112-116 can be the gateways described in U.S. Provisional Patent Application No. 62/951,897 filed Dec. 20, 2019, the entirety of which is incorporated by reference herein. In some embodiments, the applications 110 can be deployed on the edge platform 102. In this regard, lower latency in management of the building subsystems 122 can be realized.

The edge platform 102 can be connected to the cloud platform 106 via a network 104. The network 104 can communicatively couple the devices and systems of building data platform 100. In some embodiments, the network 104 is at least one of and/or a combination of a Wi-Fi network, a wired Ethernet network, a ZigBee network, a Bluetooth network, and/or any other wireless network. The network 104 may be a local area network or a wide area network (e.g., the Internet, a building WAN, etc.) and may use a variety of communications protocols (e.g., BACnet, IP, LON, etc.). The network 104 may include routers, modems, servers, cell towers, satellites, and/or network switches. The network 104 may be a combination of wired and wireless networks.

The cloud platform 106 can be configured to facilitate communication and routing of messages between the applications 110, the twin manager 108, the edge platform 102, and/or any other system. The cloud platform 106 can include a platform manager 128, a messaging manager 140, a command processor 136, and an enrichment manager 138. In some embodiments, the cloud platform 106 can facilitate messaging between the building data platform 100 via the network 104.

The messaging manager 140 can be configured to operate as a transport service that controls communication with the building subsystems 122 and/or any other system, e.g., managing commands to devices (C2D), commands to connectors (C2C) for external systems, commands from the device to the cloud (D2C), and/or notifications. The messaging manager 140 can receive different types of data from the applications 110, the twin manager 108, and/or the edge platform 102. The messaging manager 140 can receive change on value data 142, e.g., data that indicates that a value of a point has changed. The messaging manager 140 can receive timeseries data 144, e.g., a time correlated series of data entries each associated with a particular time stamp. Furthermore, the messaging manager 140 can receive command data 146. All of the messages handled by the cloud platform 106 can be handled as an event, e.g., the data 142-146 can each be packaged as an event with a data value occurring at a particular time (e.g., a temperature measurement made at a particular time).

The cloud platform 106 includes a command processor 136. The command processor 136 can be configured to receive commands to perform an action from the applications 110, the building subsystems 122, the user device 176, etc. The command processor 136 can manage the commands, determine whether the commanding system is authorized to perform the particular commands, and communicate the commands to the commanded system, e.g., the building subsystems 122 and/or the applications 110. The commands could be a command to change an operational setting that control environmental conditions of a building, a command to run analytics, etc.

The cloud platform 106 includes an enrichment manager 138. The enrichment manager 138 can be configured to enrich the events received by the messaging manager 140. The enrichment manager 138 can be configured to add contextual information to the events. The enrichment manager 138 can communicate with the twin manager 108 to retrieve the contextual information. In some embodiments, the contextual information is an indication of information related to the event. For example, if the event is a timeseries temperature measurement of a thermostat, contextual information such as the location of the thermostat (e.g., what room), the equipment controlled by the thermostat (e.g., what VAV), etc. can be added to the event. In this regard, when a consuming application, e.g., one of the applications 110 receives the event, the consuming application can operate based on the data of the event, the temperature measurement, and also the contextual information of the event.

The enrichment manager 138 can solve a problem that when a device produces a significant amount of information, the information may contain simple data without context. An example might include the data generated when a user scans a badge at a badge scanner of the building subsystems 122. This physical event can generate an output event including such information as “DeviceBadgeScannerID,” “BadgeID,” and/or “Date/Time.” However, if a system sends this data to a consuming application, e.g., Consumer A and a Consumer B, each customer may need to call the building data platform knowledge service to query information with queries such as, “What space, build, floor is that badge scanner in?” or “What user is associated with that badge?”

By performing enrichment on the data feed, a system can be able to perform inferences on the data. A result of the enrichment may be transformation of the message “DeviceBadgeScannerId, BadgeId, Date/Time,” to “Region, Building, Floor, Asset, DeviceId, BadgeId, UserName, EmployeeId, Date/Time Scanned.” This can be a significant optimization, as a system can reduce the number of calls by 1/n, where n is the number of consumers of this data feed.

By using this enrichment, a system can also have the ability to filter out undesired events. If there are 100 building in a campus that receive 100,000 events per building each hour, but only 1 building is actually commissioned, only 1/10 of the events are enriched. By looking at what events are enriched and what events are not enriched, a system can do traffic shaping of forwarding of these events to reduce the cost of forwarding events that no consuming application wants or reads.

An example of an event received by the enrichment manager 138 may be:

{
“id”: “someguid”,
“eventType”: “Device_Heartbeat”,
“eventTime”: “2018-01-27T00:00:00+00:00”
“eventValue”: 1,
“deviceID”: “someguid”
}

An example of an enriched event generated by the enrichment manager 138 may be:

{
“id”: “someguid”,
“eventType”: “Device_Heartbeat”,
“eventTime”: “2018-01-27T00:00:00+00:00”
“eventValue”: 1,
“deviceID”: “someguid”,
“buildingName”: “Building-48”,
“buildingID”: “SomeGuid”,
“panelID”: “SomeGuid”,
“panelName”: “Building-48-Panel-13”,
“cityID”: 371,
“cityName”: “Milwaukee”,
“stateID”: 48,
“stateName”: “Wisconsin (WI)”,
“countryID”: 1,
“countryName”: “United States”
}

By receiving enriched events, an application of the applications 110 can be able to populate and/or filter what events are associated with what areas. Furthermore, user interface generating applications can generate user interfaces that include the contextual information based on the enriched events.

The cloud platform 106 includes a platform manager 128. The platform manager 128 can be configured to manage the users and/or subscriptions of the cloud platform 106. For example, what subscribing building, user, and/or tenant utilizes the cloud platform 106. The platform manager 128 includes a provisioning service 130 configured to provision the cloud platform 106, the edge platform 102, and the twin manager 108. The platform manager 128 includes a subscription service 132 configured to manage a subscription of the building, user, and/or tenant while the entitlement service 134 can track entitlements of the buildings, users, and/or tenants.

The twin manager 108 can be configured to manage and maintain a digital twin. The digital twin can be a digital representation of the physical environment, e.g., a building. The twin manager 108 can include a change feed generator 152, a schema and ontology 154, a projection manager 156, a policy manager 158, an entity, relationship, and event database 160, and a graph projection database 162.

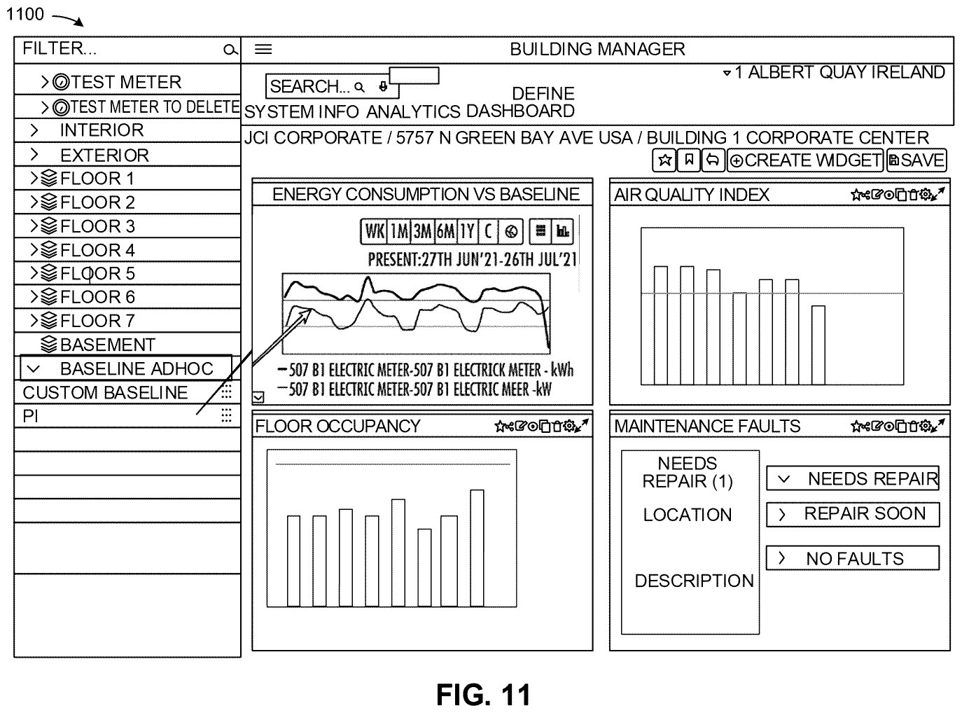

The graph projection manager 156 can be configured to construct graph projections and store the graph projections in the graph projection database 162. Examples of graph projections are shown in FIGS. 11-13. Entities, relationships, and events can be stored in the database 160. The graph projection manager 156 can retrieve entities, relationships, and/or events from the database 160 and construct a graph projection based on the retrieved entities, relationships and/or events. In some embodiments, the database 160 includes an entity-relationship collection for multiple subscriptions. Subscriptions can be subscriptions of a particular tenant as described in FIG. 24.

In some embodiment, the graph projection manager 156 generates a graph projection for a particular user, application, subscription, and/or system. In this regard, the graph projection can be generated based on policies for the particular user, application, and/or system in addition to an ontology specific for that user, application, and/or system. In this regard, an entity could request a graph projection and the graph projection manager 156 can be configured to generate the graph projection for the entity based on policies and an ontology specific to the entity. The policies can indicate what entities, relationships, and/or events the entity has access to. The ontology can indicate what types of relationships between entities the requesting entity expects to see, e.g., floors within a building, devices within a floor, etc. Another requesting entity may have an ontology to see devices within a building and applications for the devices within the graph.

The graph projections generated by the graph projection manager 156 and stored in the graph projection database 162 can be a knowledge graph and is an integration point. For example, the graph projections can represent floor plans and systems associated with each floor. Furthermore, the graph projections can include events, e.g., telemetry data of the building subsystems 122. The graph projections can show application services as nodes and API calls between the services as edges in the graph. The graph projections can illustrate the capabilities of spaces, users, and/or devices. The graph projections can include indications of the building subsystems 122, e.g., thermostats, cameras, VAVs, etc. The graph projection database 162 can store graph projections that keep up a current state of a building.

The graph projections of the graph projection database 162 can be digital twins of a building. Digital twins can be digital replicas of physical entities that enable an in-depth analysis of data of the physical entities and provide the potential to monitor systems to mitigate risks, manage issues, and utilize simulations to test future solutions. Digital twins can play an important role in helping technicians find the root cause of issues and solve problems faster, in supporting safety and security protocols, and in supporting building managers in more efficient use of energy and other facilities resources. Digital twins can be used to enable and unify security systems, employee experience, facilities management, sustainability, etc.

In some embodiments the enrichment manager 138 can use a graph projection of the graph projection database 162 to enrich events. In some embodiments, the enrichment manager 138 can identify nodes and relationships that are associated with, and are pertinent to, the device that generated the event. For example, the enrichment manager 138 could identify a thermostat generating a temperature measurement event within the graph. The enrichment manager 138 can identify relationships between the thermostat and spaces, e.g., a zone that the thermostat is located in. The enrichment manager 138 can add an indication of the zone to the event.

Furthermore, the command processor 136 can be configured to utilize the graph projections to command the building subsystems 122. The command processor 136 can identify a policy for a commanding entity within the graph projection to determine whether the commanding entity has the ability to make the command. For example, the command processor 136, before allowing a user to make a command, determine, based on the graph projection database 162, to determine that the user has a policy to be able to make the command.

In some embodiments, the policies can be conditional based policies. For example, the building data platform 100 can apply one or more conditional rules to determine whether a particular system has the ability to perform an action. In some embodiments, the rules analyze a behavioral based biometric. For example, a behavioral based biometric can indicate normal behavior and/or normal behavior rules for a system. In some embodiments, when the building data platform 100 determines, based on the one or more conditional rules, that an action requested by a system does not match a normal behavior, the building data platform 100 can deny the system the ability to perform the action and/or request approval from a higher level system.

For example, a behavior rule could indicate that a user has access to log into a system with a particular IP address between 8 A.M. through 5 P.M. However, if the user logs in to the system at 7 P.M., the building data platform 100 may contact an administrator to determine whether to give the user permission to log in.

The change feed generator 152 can be configured to generate a feed of events that indicate changes to the digital twin, e.g., to the graph. The change feed generator 152 can track changes to the entities, relationships, and/or events of the graph. For example, the change feed generator 152 can detect an addition, deletion, and/or modification of a node or edge of the graph, e.g., changing the entities, relationships, and/or events within the database 160. In response to detecting a change to the graph, the change feed generator 152 can generate an event summarizing the change. The event can indicate what nodes and/or edges have changed and how the nodes and edges have changed. The events can be posted to a topic by the change feed generator 152.

The change feed generator 152 can implement a change feed of a knowledge graph. The building data platform 100 can implement a subscription to changes in the knowledge graph. When the change feed generator 152 posts events in the change feed, subscribing systems or applications can receive the change feed event. By generating a record of all changes that have happened, a system can stage data in different ways, and then replay the data back in whatever order the system wishes. This can include running the changes sequentially one by one and/or by jumping from one major change to the next. For example, to generate a graph at a particular time, all change feed events up to the particular time can be used to construct the graph.

The change feed can track the changes in each node in the graph and the relationships related to them, in some embodiments. If a user wants to subscribe to these changes and the user has proper access, the user can simply submit a web API call to have sequential notifications of each change that happens in the graph. A user and/or system can replay the changes one by one to reinstitute the graph at any given time slice. Even though the messages are “thin” and only include notification of change and the reference “id/seq id,” the change feed can keep a copy of every state of each node and/or relationship so that a user and/or system can retrieve those past states at any time for each node. Furthermore, a consumer of the change feed could also create dynamic “views” allowing different “snapshots” in time of what the graph looks like from a particular context. While the twin manager 108 may contain the history and the current state of the graph based upon schema evaluation, a consumer can retain a copy of that data, and thereby create dynamic views using the change feed.

The schema and ontology 154 can define the message schema and graph ontology of the twin manager 108. The message schema can define what format messages received by the messaging manager 140 should have, e.g., what parameters, what formats, etc. The ontology can define graph projections, e.g., the ontology that a user wishes to view. For example, various systems, applications, and/or users can be associated with a graph ontology. Accordingly, when the graph projection manager 156 generates an graph projection for a user, system, or subscription, the graph projection manager 156 can generate a graph projection according to the ontology specific to the user. For example, the ontology can define what types of entities are related in what order in a graph, for example, for the ontology for a subscription of “Customer A,” the graph projection manager 156 can create relationships for a graph projection based on the rule:
Region F←→Building F←→Floor F←→Space←→Asset

For the ontology of a subscription of “Customer B,” the graph projection manager 156 can create relationships based on the rule:

Building F←→Floor←→Asset

The policy manager 158 can be configured to respond to requests from other applications and/or systems for policies. The policy manager 158 can consult a graph projection to determine what permissions different applications, users, and/or devices have. The graph projection can indicate various permissions that different types of entities have and the policy manager 158 can search the graph projection to identify the permissions of a particular entity. The policy manager 158 can facilitate fine grain access control with user permissions. The policy manager 158 can apply permissions across a graph, e.g., if “user can view all data associated with floor 1” then they see all subsystem data for that floor, e.g., surveillance cameras, HVAC devices, fire detection and response devices, etc.

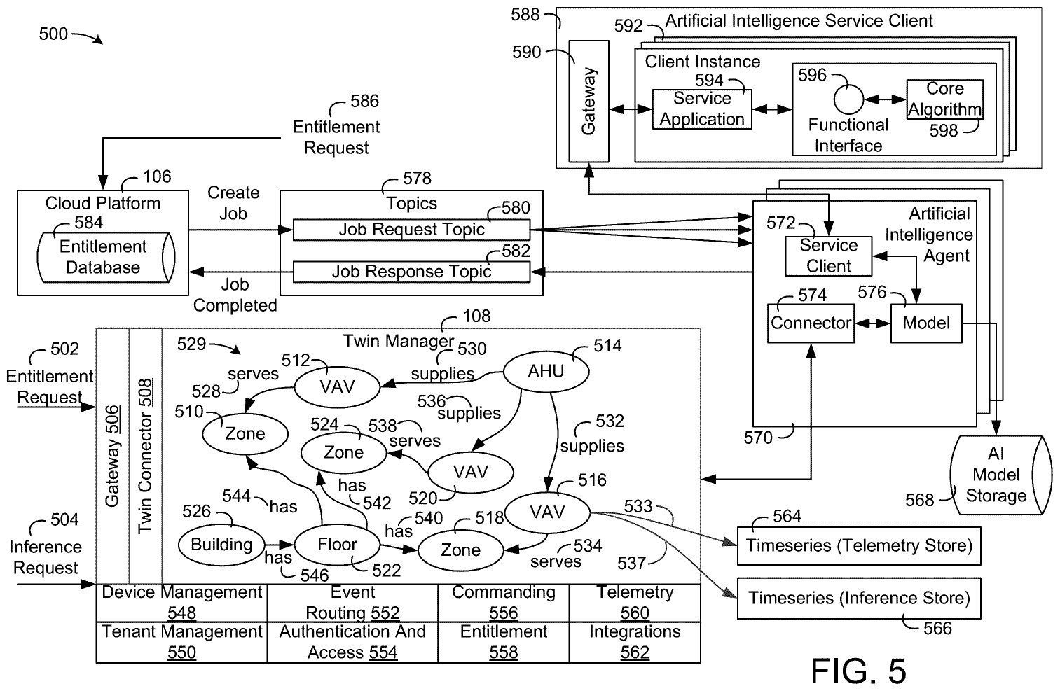

The twin manager 108 includes a query manager 165 and a twin function manager 167. The query manager 164 can be configured to handle queries received from a requesting system, e.g., the user device 176, the applications 110, and/or any other system. The query manager 165 can receive queries that include query parameters and context. The query manager 165 can query the graph projection database 162 with the query parameters to retrieve a result. The query manager 165 can then cause an event processor, e.g., a twin function, to operate based on the result and the context. In some embodiments, the query manager 165 can select the twin function based on the context and/or perform operations based on the context. In some embodiments, the query manager 165 is configured to perform the operations described with reference to FIGS. 5-10.

The twin function manager 167 can be configured to manage the execution of twin functions. The twin function manager 167 can receive an indication of a context query that identifies a particular data element and/or pattern in the graph projection database 162. Responsive to the particular data element and/or pattern occurring in the graph projection database 162 (e.g., based on a new data event added to the graph projection database 162 and/or change to nodes or edges of the graph projection database 162, the twin function manager 167 can cause a particular twin function to execute. The twin function can execute based on an event, context, and/or rules. The event can be data that the twin function executes against. The context can be information that provides a contextual description of the data, e.g., what device the event is associated with, what control point should be updated based on the event, etc. The twin function manager 167 can be configured to perform the operations of the FIGS. 11-15.

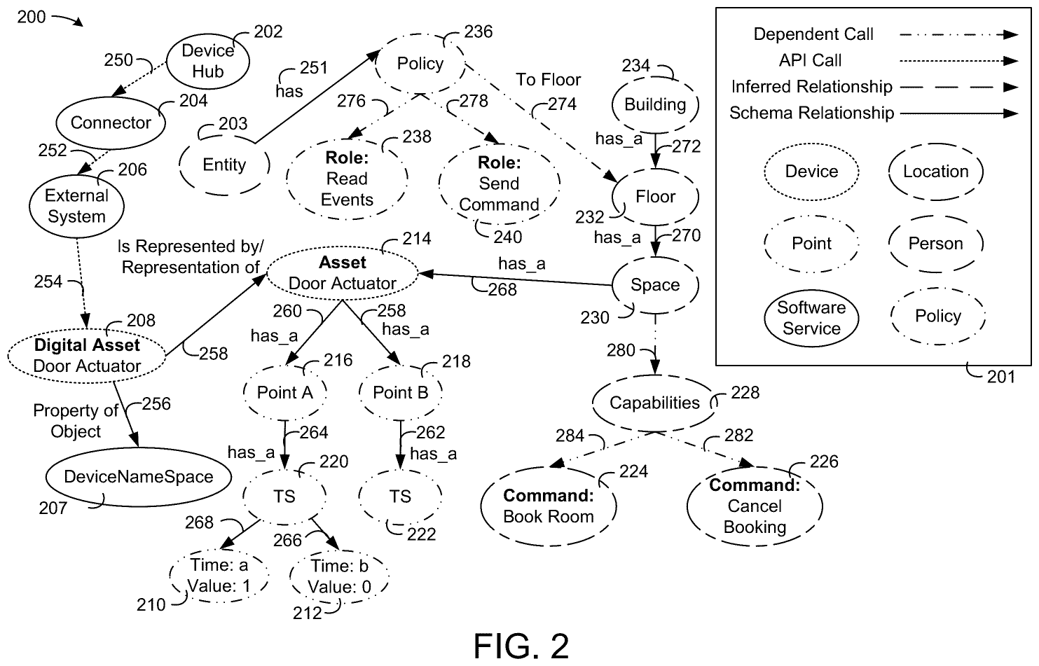

Referring now to FIG. 2, a graph projection 200 of the twin manager 108 including application programming interface (API) data, capability data, policy data, and services is shown, according to an exemplary embodiment. The graph projection 200 includes nodes 202-240 and edges 250-272. The nodes 202-240 and the edges 250-272 are defined according to the key 201. The nodes 202-240 represent different types of entities, devices, locations, points, persons, policies, and software services (e.g., API services). The edges 250-272 represent relationships between the nodes 202-240, e.g., dependent calls, API calls, inferred relationships, and schema relationships (e.g., BRICK relationships).

The graph projection 200 includes a device hub 202 which may represent a software service that facilitates the communication of data and commands between the cloud platform 106 and a device of the building subsystems 122, e.g., door actuator 214. The device hub 202 is related to a connector 204, an external system 206, and a digital asset “Door Actuator” 208 by edge 250, edge 252, and edge 254.

The cloud platform 106 can be configured to identify the device hub 202, the connector 204, the external system 206 related to the door actuator 214 by searching the graph projection 200 and identifying the edges 250-254 and edge 258. The graph projection 200 includes a digital representation of the “Door Actuator,” node 208. The digital asset “Door Actuator” 208 includes a “DeviceNameSpace” represented by node 207 and related to the digital asset “Door Actuator” 208 by the “Property of Object” edge 256.

The “Door Actuator” 214 has points and timeseries. The “Door Actuator” 214 is related to “Point A” 216 by a “has_a” edge 260. The “Door Actuator” 214 is related to “Point B” 218 by a “has_A” edge 258. Furthermore, timeseries associated with the points A and B are represented by nodes “TS” 220 and “TS” 222. The timeseries are related to the points A and B by “has_a” edge 264 and “has_a” edge 262. The timeseries “TS” 220 has particular samples, sample 210 and 212 each related to “TS” 220 with edges 268 and 266 respectively. Each sample includes a time and a value. Each sample may be an event received from the door actuator that the cloud platform 106 ingests into the entity, relationship, and event database 160, e.g., ingests into the graph projection 200.

The graph projection 200 includes a building 234 representing a physical building. The building includes a floor represented by floor 232 related to the building 234 by the “has_a” edge from the building 234 to the floor 232. The floor has a space indicated by the edge “has_a” 270 between the floor 232 and the space 230. The space has particular capabilities, e.g., is a room that can be booked for a meeting, conference, private study time, etc. Furthermore, the booking can be canceled. The capabilities for the floor 232 are represented by capabilities 228 related to space 230 by edge 280. The capabilities 228 are related to two different commands, command “book room” 224 and command “cancel booking” 226 related to capabilities 228 by edge 284 and edge 282 respectively.

If the cloud platform 106 receives a command to book the space represented by the node, space 230, the cloud platform 106 can search the graph projection 200 for the capabilities for the 228 related to the space 230 to determine whether the cloud platform 106 can book the room.

In some embodiments, the cloud platform 106 could receive a request to book a room in a particular building, e.g., the building 234. The cloud platform 106 could search the graph projection 200 to identify spaces that have the capabilities to be booked, e.g., identify the space 230 based on the capabilities 228 related to the space 230. The cloud platform 106 can reply to the request with an indication of the space and allow the requesting entity to book the space 230.

The graph projection 200 includes a policy 236 for the floor 232. The policy 236 is related set for the floor 232 based on a “To Floor” edge 274 between the policy 236 and the floor 232. The policy 236 is related to different roles for the floor 232, read events 238 via edge 276 and send command 240 via edge 278. The policy 236 is set for the entity 203 based on has edge 251 between the entity 203 and the policy 236.

The twin manager 108 can identify policies for particular entities, e.g., users, software applications, systems, devices, etc. based on the policy 236. For example, if the cloud platform 106 receives a command to book the space 230. The cloud platform 106 can communicate with the twin manager 108 to verify that the entity requesting to book the space 230 has a policy to book the space. The twin manager 108 can identify the entity requesting to book the space as the entity 203 by searching the graph projection 200. Furthermore, the twin manager 108 can further identify the edge has 251 between the entity 203 and the policy 236 and the edge 1178 between the policy 236 and the command 240.

Furthermore, the twin manager 108 can identify that the entity 203 has the ability to command the space 230 based on the edge 1174 between the policy 236 and the edge 270 between the floor 232 and the space 230. In response to identifying the entity 203 has the ability to book the space 230, the twin manager 108 can provide an indication to the cloud platform 106.

Furthermore, if the entity makes a request to read events for the space 230, e.g., the sample 210 and the sample 212, the twin manager 108 can identify the edge has 251 between the entity 203 and the policy 236, the edge 1178 between the policy 236 and the read events 238, the edge 1174 between the policy 236 and the floor 232, the “has_a” edge 270 between the floor 232 and the space 230, the edge 268 between the space 230 and the door actuator 214, the edge 260 between the door actuator 214 and the point A 216, the “has_a” edge 264 between the point A 216 and the TS 220, and the edges 268 and 266 between the TS 220 and the samples 210 and 212 respectively.

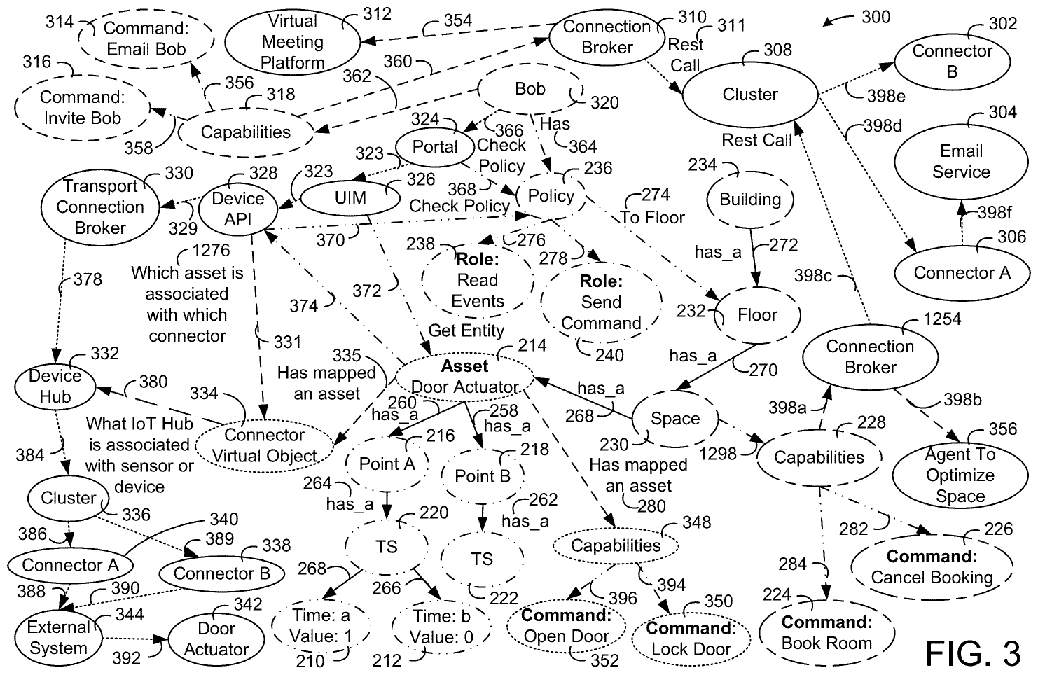

Referring now to FIG. 3, a graph projection 300 of the twin manager 108 including application programming interface (API) data, capability data, policy data, and services is shown, according to an exemplary embodiment. The graph projection 300 includes the nodes and edges described in the graph projection 200 of FIG. 2. The graph projection 300 includes a connection broker 354 related to capabilities 228 by edge 398a. The connection broker 354 can be a node representing a software application configured to facilitate a connection with another software application. In some embodiments, the cloud platform 106 can identify the system that implements the capabilities 228 by identifying the edge 398a between the capabilities 228 and the connection broker 354.

The connection broker 354 is related to an agent that optimizes a space 356 via edge 398b. The agent represented by the node 356 can book and cancel bookings for the space represented by the node 230 based on the edge 398b between the connection broker 354 and the node 356 and the edge 398a between the capabilities 228 and the connection broker 354.

The connection broker 354 is related to a cluster 308 by edge 398c. Cluster 308 is related to connector B 302 via edge 398e and connector A 306 via edge 398d. The connector A 306 is related to an external subscription service 304. A connection broker 310 is related to cluster 308 via an edge 311 representing a rest call that the connection broker represented by node 310 can make to the cluster represented by cluster 308.

The connection broker 310 is related to a virtual meeting platform 312 by an edge 354. The node 312 represents an external system that represents a virtual meeting platform. The connection broker represented by node 310 can represent a software component that facilitates a connection between the cloud platform 106 and the virtual meeting platform represented by node 312. When the cloud platform 106 needs to communicate with the virtual meeting platform represented by the node 312, the cloud platform 106 can identify the edge 354 between the connection broker 310 and the virtual meeting platform 312 and select the connection broker represented by the node 310 to facilitate communication with the virtual meeting platform represented by the node 312.

A capabilities node 318 can be connected to the connection broker 310 via edge 360. The capabilities 318 can be capabilities of the virtual meeting platform represented by the node 312 and can be related to the node 312 through the edge 360 to the connection broker 310 and the edge 354 between the connection broker 310 and the node 312. The capabilities 318 can define capabilities of the virtual meeting platform represented by the node 312. The node 320 is related to capabilities 318 via edge 362. The capabilities may be an invite bob command represented by node 316 and an email bob command represented by node 314. The capabilities 318 can be linked to a node 320 representing a user, Bob. The cloud platform 106 can facilitate email commands to send emails to the user Bob via the email service represented by the node 304. The node 304 is related to the connect a node 306 via edge 398f. Furthermore, the cloud platform 106 can facilitate sending an invite for a virtual meeting via the virtual meeting platform represented by the node 312 linked to the node 318 via the edge 358.

The node 320 for the user Bob can be associated with the policy 236 via the “has” edge 364. Furthermore, the node 320 can have a “check policy” edge 366 with a portal node 324. The device API node 328 has a check policy edge 370 to the policy node 236. The portal node 324 has an edge 368 to the policy node 236. The portal node 324 has an edge 323 to a node 326 representing a user input manager (UIM). The portal node 324 is related to the UIM node 326 via an edge 323. The UIM node 326 has an edge 323 to a device API node 328. The UIM node 326 is related to the door actuator node 214 via edge 372. The door actuator node 214 has an edge 374 to the device API node 328. The door actuator 214 has an edge 335 to the connector virtual object 334. The device hub 332 is related to the connector virtual object via edge 380. The device API node 328 can be an API for the door actuator 214. The connector virtual object 334 is related to the device API node 328 via the edge 331.

The device API node 328 is related to a transport connection broker 330 via an edge 329. The transport connection broker 330 is related to a device hub 332 via an edge 378. The device hub represented by node 332 can be a software component that hands the communication of data and commands for the door actuator 214. The cloud platform 106 can identify where to store data within the graph projection 300 received from the door actuator by identifying the nodes and edges between the points 216 and 218 and the device hub node 332. Similarly, the cloud platform 308 can identify commands for the door actuator that can be facilitated by the device hub represented by the node 332, e.g., by identifying edges between the device hub node 332 and an open door node 352 and an lock door node 350. The door actuator 114 has an edge “has mapped an asset” 280 between the node 214 and a capabilities node 348. The capabilities node 348 and the nodes 352 and 350 are linked by edges 396 and 394.

The device hub 332 is linked to a cluster 336 via an edge 384. The cluster 336 is linked to connector A 340 and connector B 338 by edges 386 and the edge 389. The connector A 340 and the connector B 338 is linked to an external system 344 via edges 388 and 390. The external system 344 is linked to a door actuator 342 via an edge 392.

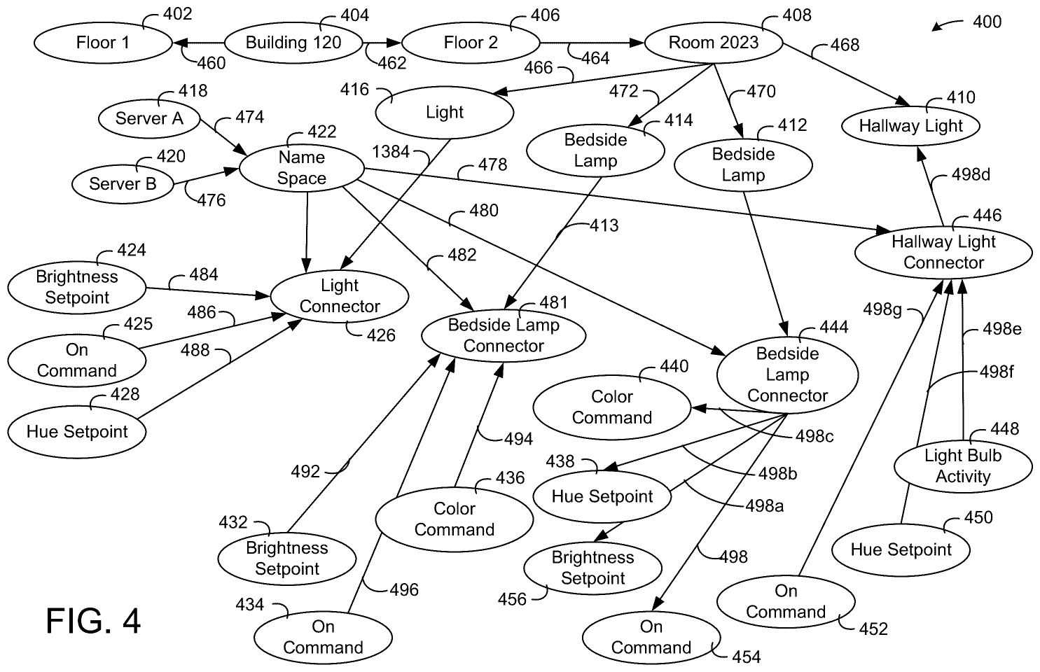

Referring now to FIG. 4, a graph projection 400 of the twin manager 108 including equipment and capability data for the equipment is shown, according to an exemplary embodiment. The graph projection 400 includes nodes 402-456 and edges 360-498f. The cloud platform 106 can search the graph projection 400 to identify capabilities of different pieces of equipment.

A building node 404 represents a particular building that includes two floors. A floor 1 node 402 is linked to the building node 404 via edge 460 while a floor 2 node 406 is linked to the building node 404 via edge 462. The floor 2 includes a particular room 2023 represented by edge 464 between floor 2 node 406 and room 2023 node 408. Various pieces of equipment are included within the room 2023. A light represented by light node 416, a bedside lamp node 414, a bedside lamp node 412, and a hallway light node 410 are related to room 2023 node 408 via edge 466, edge 472, edge 470, and edge 468.

The light represented by light node 416 is related to a light connector 426 via edge 484. The light connector 426 is related to multiple commands for the light represented by the light node 416 via edges 484, 486, and 488. The commands may be a brightness setpoint 424, an on command 425, and a hue setpoint 428. The cloud platform 106 can receive a request to identify commands for the light represented by the light 416 and can identify the nodes 424-428 and provide an indication of the commands represented by the node 424-428 to the requesting entity. The requesting entity can then send commands for the commands represented by the nodes 424-428.

The bedside lamp node 414 is linked to a bedside lamp connector 481 via an edge 413. The connector 481 is related to commands for the bedside lamp represented by the bedside lamp node 414 via edges 492, 496, and 494. The command nodes are a brightness setpoint node 432, an on command node 434, and a color command 436. The hallway light 410 is related to a hallway light connector 446 via an edge 498d. The hallway light connector 446 is linked to multiple commands for the hallway light node 410 via edges 498g, 498f, and 498e. The commands are represented by an on command node 452, a hue setpoint node 450, and a light bulb activity node 448.

The graph projection 400 includes a name space node 422 related to a server A node 418 and a server B node 420 via edges 474 and 476. The name space node 422 is related to the bedside lamp connector 481, the bedside lamp connector 444, and the hallway light connector 446 via edges 482, 480, and 478. The bedside lamp connector 444 is related to commands, e.g., the color command node 440, the hue setpoint command 438, a brightness setpoint command 456, and an on command 454 via edges 498c, 498b, 498a, and 498.

Referring now to FIG. 5, a system 500 for managing a digital twin where an artificial intelligence agent can be executed to infer and/or predict information for an entity of a graph is shown, according to an exemplary embodiment. The system 500 can be components of the building data platform 100, e.g., components run on the processors and memories of the edge platform 102, the cloud platform 106, the twin manager 108, and/or the applications 110. The system 500 can, in some implementations, implement a digital twin with artificial intelligence.

A digital twin (or a shadow) may be a computing entity that describes a physical thing (e.g., a building, spaces of a building, devices of a building, people of the building, equipment of the building, etc.) through modeling the physical thing through a set of attributes that define the physical thing. A digital twin can refer to a digital replica of physical assets (a physical device twin) and can be extended to store processes, people, places, systems that can be used for various purposes. The digital twin can include both the ingestion of information and actions learned and executed through artificial intelligence agents.

In FIG. 5, the digital twin can be a graph 529 managed by the twin manager 108 and/or artificial intelligence agents 570. In some embodiments, the digital twin is the combination of the graph 529 with the artificial intelligence agents 570. In some embodiments, the digital twin enables the creation of a chronological time-series database of telemetry events for analytical purposes. In some embodiments, the graph 529 uses the BRICK schema.

The twin manager 108 stores the graph 529 which may be a graph data structure including various nodes and edges interrelating the nodes. The graph 529 may be the same as, or similar to, the graph projections described herein with reference to FIGS. 1-4. The graph 529 includes nodes 510-526 and edges 528-546. The graph 529 includes a building node 526 representing a building that has a floor indicated by the “has” edge 546 to the floor node 522. The floor node 522 is related to a zone node 510 via a “has” edge 544 indicating that the floor represented by the node 522 has a zone represented by the zone 510.

The floor node 522 is related to the zone node 518 by the “has” edge 540 indicating that the floor represented by the floor node 522 has another zone represented by the zone node 518. The floor node 522 is related to another zone node 524 via a “has” edge 542 representing that the floor represented by the floor node 522 has a third zone represented by the zone node 524.

The graph 529 includes an AHU node 514 representing an AHU of the building represented by the building node 526. The AHU node 514 is related by a “supplies” edge 530 to the VAV node 512 to represent that the AHU represented by the AHU node 514 supplies air to the VAV represented by the VAV node 512. The AHU node 514 is related by a “supplies” edge 536 to the VAV node 520 to represent that the AHU represented by the AHU node 514 supplies air to the VAV represented by the VAV node 520. The AHU node 514 is related by a “supplies” edge 532 to the VAV node 516 to represent that the AHU represented by the AHU node 514 supplies air to the VAV represented by the VAV node 516.

The VAV node 516 is related to the zone node 518 via the “serves” edge 534 to represent that the VAV represented by the VAV node 516 serves (e.g., heats or cools) the zone represented by the zone node 518. The VAV node 520 is related to the zone node 524 via the “serves” edge 538 to represent that the VAV represented by the VAV node 520 serves (e.g., heats or cools) the zone represented by the zone node 524. The VAV node 512 is related to the zone node 510 via the “serves” edge 528 to represent that the VAV represented by the VAV node 512 serves (e.g., heats or cools) the zone represented by the zone node 510.

Furthermore, the graph 529 includes an edge 533 related to a timeseries node 564. The timeseries node 564 can be information stored within the graph 529 and/or can be information stored outside the graph 529 in a different database (e.g., a timeseries database). In some embodiments, the timeseries node 564 stores timeseries data (or any other type of data) for a data point of the VAV represented by the VAV node 516. The data of the timeseries node 564 can be aggregated and/or collected telemetry data of the timeseries node 564.

Furthermore, the graph 529 includes an edge 537 related to a timeseries node 566. The timeseries node 566 can be information stored within the graph 529 and/or can be information stored outside the graph 529 in a different database (e.g., a timeseries database). In some embodiments, the timeseries node 566 stores timeseries data (or any other type of data) for a data point of the VAV represented by the VAV node 516. The data of the timeseries node 564 can be inferred information, e.g., data inferred by one of the artificial intelligence agents 570 and written into the timeseries node 564 by the artificial intelligence agent 570. In some embodiments, the timeseries 546 and/or 566 are stored in the graph 529 but are stored as references to timeseries data stored in a timeseries database.

The twin manager 108 includes various software components. For example, the twin manager 108 includes a device management component 548 for managing devices of a building. The twin manager 108 includes a tenant management component 550 for managing various tenant subscriptions. The twin manager 108 includes an event routing component 552 for routing various events. The twin manager 108 includes an authentication and access component 554 for performing user and/or system authentication and grating the user and/or system access to various spaces, pieces of software, devices, etc. The twin manager 108 includes a commanding component 556 allowing a software application and/or user to send commands to physical devices. The twin manager 108 includes an entitlement component 558 that analyzes the entitlements of a user and/or system and grants the user and/or system abilities based on the entitlements. The twin manager 108 includes a telemetry component 560 that can receive telemetry data from physical systems and/or devices and ingest the telemetry data into the graph 529. Furthermore, the twin manager 108 includes an integrations component 562 allowing the twin manager 108 to integrate with other applications.

The twin manager 108 includes a gateway 506 and a twin connector 508. The gateway 506 can be configured to integrate with other systems and the twin connector 508 can be configured to allow the gateway 506 to integrate with the twin manager 108. The gateway 506 and/or the twin connector 508 can receive an entitlement request 502 and/or an inference request 504. The entitlement request 502 can be a request received from a system and/or a user requesting that an AI agent action be taken by the AI agent 570. The entitlement request 502 can be checked against entitlements for the system and/or user to verify that the action requested by the system and/or user is allowed for the user and/or system. The inference request 504 can be a request that the AI agent 570 generates an inference, e.g., a projection of information, a prediction of a future data measurement, an extrapolated data value, etc.

The cloud platform 106 is shown to receive an entitlement request 586. The request 586 can be received from a system, application, and/or user device (e.g., from the applications 110, the building subsystems 122, and/or the user device 176). The entitlement request 586 may be a manual or automated request. In some embodiments, the request 586 can be automated via an API request, e.g., when such an entitlement to an AI model is enabled for a particular tenant/end-customer of the data platform 100. In some embodiments, the request 586 may be a manual request by a person asking for an inference/future state of the building. The request 586 could be automatically made to keep the state updated on a particular cadence. In some embodiments, a request for a future state of one digital twin can cause a re-calculation of the future states of related digital twins automatically. For example, based on a request asking for the future occupancy of a room in a building in the coming week, a re-calculation of the future AHU operating value recommendations to reduce the spread of infectious diseases may be triggered. The results of these automatic triggers determining future states not directly requested by the request 586 can be collected and presented to the caller of the request 586 as causal future states.

The entitlement request 586 may be a request for the AI agent 570 to perform an action, e.g., an action that the requesting system and/or user has an entitlement for. The cloud platform 106 can receive the entitlement request 586 and check the entitlement request 586 against an entitlement database 584 storing a set of entitlements to verify that the requesting system has access to the user and/or system. The cloud platform 106, responsive to the entitlement request 586 being approved, can create a job for the AI agent 570 to perform. The created job can be added to a job request topic 580 of a set of topics 578.

The job request topic 580 can be fed to AI agents 570. For example, the topics 580 can be fanned out to various AI agents 570 based on the AI agent that each of the topics 580 pertains to (e.g., based on an identifier that identifies an agent and is included in each job of the topic 580). The AI agents 570 include a service client 572, a connector 574, and a model 576. The model 576 can be loaded into the AI agent 570 from a set of AI models stored in the AI model storage 568. The AI model storage 568 can store models for making energy load predictions for a building, weather forecasting models for predicting a weather forecast, action/decision models to take certain actions responsive to certain conditions being met, an occupancy model for predicting occupancy of a space and/or a building, etc. The models of the AI model storage 568 can be neural networks (e.g., convolutional neural networks, recurrent neural networks, deep learning networks, etc.), decision trees, support vector machines, and/or any other type of artificial intelligence, machine learning, and/or deep learning category.

The AI agent 570 can include a service client 572 that causes an instance of an AI agent to run. The instance can be hosted by the artificial intelligence service client 588. The client 588 can cause a client instance 592 to run and communicate with the AI agent 570 via a gateway 590. The client instance 592 can include a service application 594 that interfaces with a core algorithm 598 via a functional interface 596. The core algorithm 598 can run the model 576, e.g., train the model 576 and/or use the model 576 to make inferences and/or predictions.

In some embodiments, the core algorithm 598 can be configured to perform learning based on the graph 529. In some embodiments, the core algorithm 598 can read and/or analyze the nodes and relationships of the graph 529 to make decisions. In some embodiments, the core algorithm 598 can be configured to use telemetry data (e.g., the timeseries data 564) from the graph 529 to make inferences on and/or perform model learning. In some embodiments, the result of the inferences can be the timeseries 566. In some embodiments, the timeseries 564 is an input into the model 576 that predicts the timeseries 566.

In some embodiments, the core algorithm 598 can generate the timeseries 566 as an inference for a data point, e.g., a prediction of values for the data point at future times. The timeseries 564 may be actual data for the data point. In this regard, the core algorithm 598 can learn and train by comparing the inferred data values against the true data values. In this regard, the model 576 can be trained by the core algorithm 598 to improve the inferences made by the model 576.

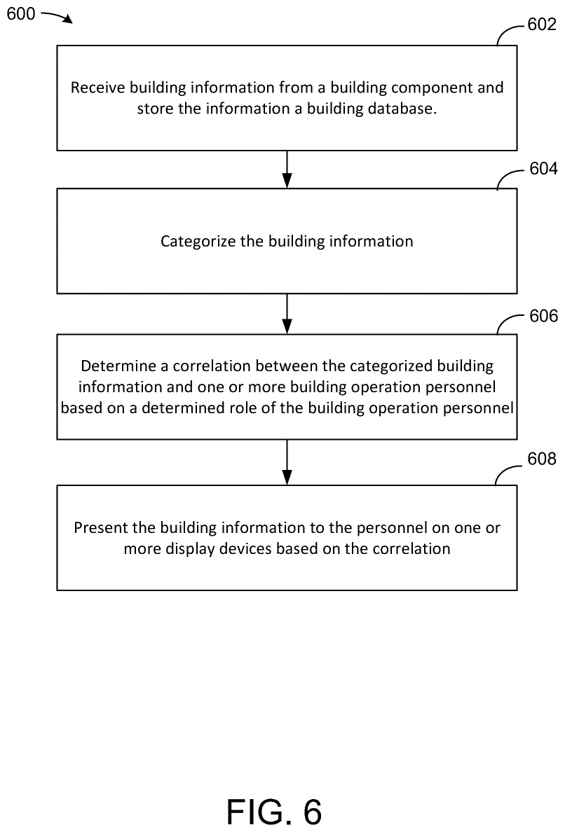

Referring now to FIG. 6, a process 600 for executing an artificial intelligence agent to categorize building data and present the building data to relevant building operation personnel is shown, according to an exemplary embodiment. The process 600 can be performed by the system and/or components of the system. The process 600 can be performed by the building data platform. Furthermore, the process 600 can be performed by any computing device described herein.

In step 602, the building platform 100 receives building information from a building component and stores the information, or a link to the information, in a building database. In one embodiment, the building information is stored in a cloud database. In another embodiment, the building information is stored in a building data platform. In another embodiment of step 602, the building information is stored in a digital twin graph. In this regard, the twin manager 108 receives building information from a building component and stores the information, or a link to the information, in the graph 529. The building information may be related to various components of a building, including building operation, security, sustainability, energy, personnel management, etc. For example, the telemetry component 560 can receive telemetry data from physical devices, e.g., the building subsystems. The telemetry data can be measured data values, a log of historical equipment commands, etc. The telemetry component can store the received information in the graph 529 by relating a node storing the information to a node representing the physical device. For example, the telemetry component 560 can store timeseries data as the timeseries along by identifying that the physical device is a VAV represented by the VAV node 516 and that an edge 537 relates the VAV node 516 to the timeseries node 566. In some embodiments, the building information received by the twin manager 108 may be related to software security. Examples of software security information received by the twin manager 108 in this step may include traffic related to a database, software logins, unsupported software version detection, connection broker activity, etc. In some embodiments, the building information received by the twin manager 108 may be related to physical building security. Examples of physical security information received by the twin manager 108 may include alarm activation, camera footage, sound monitor footage, traffic related to an event, indication of doors locking or unlocking, etc. In some embodiments, the building information received by the twin manager 108 may be related to energy. Examples of energy information received by the twin manager 108 include energy consumption, indications of baseline levels being exceeded, etc. In some embodiments, the building information received by the twin manager 108 may be related to building management. Examples of building management information received by the twin manager 108 include air quality index levels determined by data stored in the AHU node 514 or one of the one or more VAV nodes (e.g., VAV node 512, VAV node 516, VAV node 520), building occupancy, indications of maintenance faults, light bulb activity, etc. In some embodiments, the building information received by the twin manager 108 may be related to sustainability. Examples of sustainability information received by the twin manager 108 may include electrical energy information, thermal energy information, energy saving information, water information, carbon footprint information, consumption information, etc.

In step 604, the building data platform 100 categorizes the building information received at step 602. In one embodiment, the building information may be categorized by one or more processors evaluating description tags associated with the building information to determine what the building information relates to. For example, an algorithm may be used to determine common tags for building information and categorize the building information into categories associated with the common tags. Some common tags may include building management, physical security, software security, sustainability, energy, and personnel management. For example, the building data platform 100 may receive information regarding a door being opened without proper authorization. The building data platform 100 may then assign the building information to a physical security tag, further categorizing the security information into a security category. In another embodiment, the building information may be categorized using an AI agent.

In another embodiment of step 606, the twin manager 108 and/or the cloud platform 106 receives an indication to execute an artificial intelligence agent of an entity represented in the graph 529, the AI agent being associated with a model. In some embodiments, the indication is created by a user and provided via a user device, which may include user device 176. In some embodiments, the indication is created by an application, e.g., one of the applications 110.

Responsive to receiving the indication, the AI agent 570 causes a client instance 592 to run the model 576 based on the building information received in step 602. Running the model 576 will categorize the building information received in step 602 into predetermined categories. In some embodiments, predetermined categories are set based on the operations performed in the building and may vary based on the tasks performed in the building. For example, the predetermined categories for building information of a particular building may include building management, security, energy, software, sustainability, personnel management, etc. In some embodiments, the building information received in step 602 is provided directly to the AI agent 570. In some embodiments, the building information is read from the graph 529 by the AI agent 570.

In step 606, the building data platform 100 determines a correlation between the categorized building information and one or more building operation personnel. The correlation is determined based on an assigned role of the building operation personnel. In some embodiments, the correlation is determined with a process executed by one or more processors to determine a minimum correlation threshold between the information. In some embodiments, the correlation is determined between the data tag assigned to the categorized building information and a data tag related to a role assigned to the building operation personnel. For example, the building data platform 100 may receive information regarding a light bulb that needs replacement and assign the information a building management tag. Then, the building data platform 100 may run a process to determine a correlation between the information and a building manager with a building manager role tag. Upon running the process, the correlation value between the building management tag and the building manager role tag may exceed a required correlation threshold. In another embodiment, the correlation between the categorized building information and the one or more building operation personnel may be determined using an AI agent.

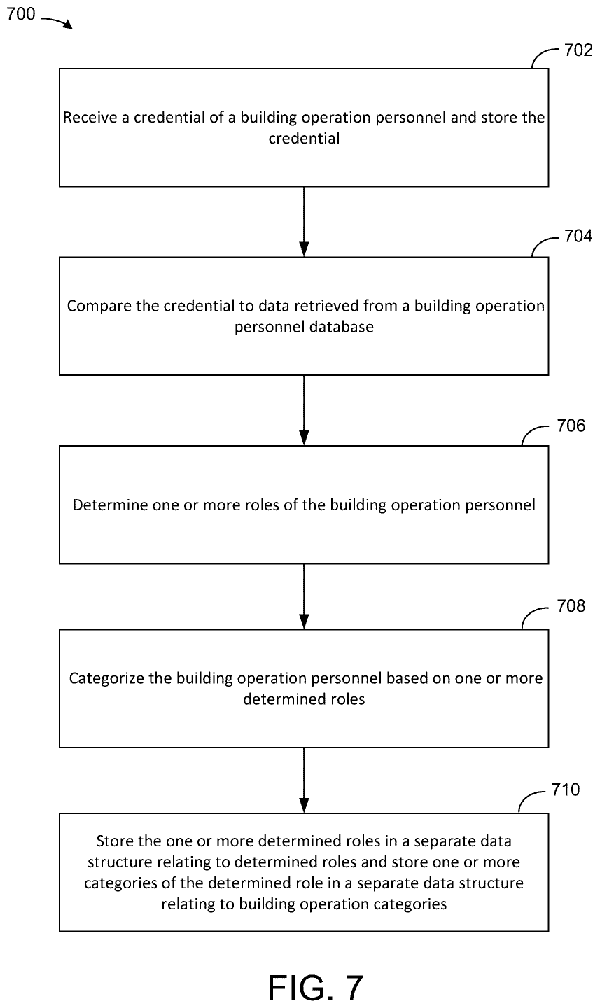

In this regard, the AI agent 570 determines a correlation between the categorized building information from step 606 and information associated with one or more building operation personnel. The correlation is determined based on an assigned role of the building operation personnel. The process 700 is shown in FIG. 7 further describes the process that the AI agent 570 executes to determine the role being assigned to the building operation personnel, as described above. In some embodiments, the AI agent 570 uses machine learning to determine a comparison between the building information and the role assigned to the building operation personnel. In some embodiments, the comparison determined by the AI agent 570 is used to determine which building operation personnel are allowed access to the building information. For example, the twin manager 108 may receive air quality information in step 602 from a sensor in an HVAC system, the information indicating that the air quality index level on the corresponding floor has risen above a desired threshold. In response, the AI agent 570 may categorize the air quality information from the sensor into one or more categories that pertain to the air quality information, such as a building management category. The AI agent 570 may then compare data regarding the building management category to the information associated with one or more building operation personnel, determining, and storing a correlation for the one or more building operation personnel that have a role relating to the building management category. In this example, determining the correlation between the categorized building management information and the building operation personnel allows the AI agent 570 to effectively match building operation personnel having an assigned role relating to building management with relevant building management information. This automatic comparison allows for more efficient and secure distribution of building information, as it eliminates the need for building operation personnel to sort through irrelevant building information, and instead automatically presents building operation personnel with relevant building information after being received. The automatic comparison determined may also ensure that every building operation personnel that relates to the received building information will receive it, which may eliminate a possibility that building operation personnel are not notified about relevant new information.

In step 608, the building data platform 100 may present the building information to the building operation personnel on one or more display devices based on the correlation. In some embodiments, step 608 results in a custom command center for each building operation personnel that will be displayed in this step. The building information may only be presented to building information personnel with a correlation value that exceeds the required correlation threshold. In one embodiment, using one or more processors, the building data platform 100 may only present the building information to building operation personnel whose tags were determined to have a correlation to the tag assigned to the building information. The display devices may be monitors, mobile devices, virtual reality devices, augmented reality devices, audio players, video devices, etc. For example, the building data platform 100 may alter the display of physical building features on an augmented reality device to direct building operation personnel to a relevant location relating to the building information. Furthering the example, information regarding an entry into the building by an unauthorized person may be received. Upon determining the correlation between the tagged information and a building personnel tag, the information may be displayed to personnel with a security guard tag via an augmented reality headset. The display shown to the security guard may include a physical indication as to where the unauthorized person was last detected (e.g., highlighting a door recently used by the unauthorized person). The tag associated with the role of the personnel may fail to have the required correlation between the role tag and the building information tag, in some embodiments. In that regard, the building data platform may not give access of the building information to the personnel. For example, building information regarding an indication of unsupported software may be received. In response, the building data platform 100 may properly tag the information with a software security tag. Then, the building data platform 100 may determine a low correlation between the software information and an energy manager. Therefore, the energy manager may not be granted access to the software information.

In another embodiment of step 608, the building information may be displayed using an AI agent, In this regard, the AI agent 570 may store the correlation in a separate data structure. Based on the correlation, the AI agent 570 may determine which display devices will be presented with the building information received in step 602. In some embodiments, the display devices are augmented reality devices, such as personal augmented reality headsets. In this regard, the AI agent 570 may alter the display of physical building features to direct building operation personnel to a relevant location relating to the building information. For example, the twin manager 108 may receive information regarding an entry into the building by an unauthorized person. Upon determining the comparison to determine which building operation personnel relate to the information, the AI agent 570 may display the information to a security guard via an augmented reality headset. The display shown to the security guard may include a physical indication as to where the unauthorized person was last detected (e.g., highlighting a door recently used by the unauthorized person). In some embodiments, the display devices are monitors, such as those in a command center. In some embodiments, the AI agent 570 may restrict access to the building operation personnel that are not matched to the building information in step 606 and show a blank screen, and the building operation personnel that are matched to the building information in step 606 will be presented with a screen populated by the data relevant to their matched category. In some embodiments, the building personnel may interact with the displayed building information to cause a change to the operation of the building. For example, via the information displayed on the command center, the personnel management user could make changes for certain temperature or window screen conditions for a single person or a group of persons associated with the building, if their determined role shows that they have the appropriate permissions based on data/tags as described above.

Referring now to FIG. 7, a process 700 for receiving a credential of a building operation personnel and storing a role for the building operation personnel is shown, according to an exemplary embodiment. The process 700 can be performed by the system and/or components of the system. The process 700 can be performed by a building operation personnel data platform. Furthermore, the process 700 can be performed by any computing device described herein.

In step 702, the building data platform 100 may receive a credential of a building operation personnel and store the credential. The credential may be stored using one or more processors. In some embodiments, the credential may be an employee ID number of the building operation personnel. In some embodiments, the credential may be a security ID code. In some embodiments, the credential may be a username and password used to access a database. The building data platform 100 may receive the credential in a variety of ways. In some embodiments, the building data platform 100 may receive the credential when a building operation personnel logs into an operation system. In some embodiments, the building data platform 100 may receive the credential when the building operation personnel enters the building and scans a personal identification key through a security sensor.

In another embodiment of step 702, the credential may be received by the twin manager 108. In some embodiments, the credential may be an employee ID number of the building operation personnel. In some embodiments, the credential may be a security ID code. In some embodiments, the credential may be a username and password used to access a database. The twin manager 108 may receive the credential in a variety of ways. In some embodiments, the twin manager 108 may receive the credential when a building operation personnel logs in to an operation system. In some embodiments, the twin manager 108 may receive the credential when a building operation personnel enters the building and scans a personal identification key through a security sensor.

In step 704, the building data platform 100 may determine a comparison between the credential received in step 702 and information predisposed in a data structure relating to building operation personnel role tags. The comparison may be determined using one or more processors. In some embodiments, the building data platform may utilize one or more processors to determine a correlation between the received credential and data stored in the data structure. In another embodiment, the comparison is determined using an AI agent.

In this regard, the AI agent 570 may determine a comparison between the credential received in step 702 and information predisposed in a separate building operation personnel data structure. In some embodiments, the AI agent 570 compares the information with a machine learning algorithm to determine a correlation. In some embodiments, the machine learning algorithm may determine a correlation based on patterns identified in data stored from correlations determined in previous instances of receiving credentials. For example, a credential may be received by the twin manager 108, in the form of a username and password for vulnerability report access. The machine learning algorithm may detect data patterns between the credential and other credentials previously used to access the vulnerability report, which may be used to determine the correlation. The machine learning algorithm may detect the data patterns in a variety of ways. For example, the machine learning algorithm may recognize a common number sequence between user names assigned to building operation personnel who have been granted access to security information. The recognition of the number sequence may prompt the machine learning algorithm to categorize other building operation personnel with the number sequence into the security category. In some embodiments, the machine learning algorithm can determine the correlation using history of information that the building operation personnel has previously been granted access to.

Responsive to determining the correlation, in step 706, the building data platform 100 assigns one or more role tags to the building operation personnel. For example, a building operation personnel may be assigned to a building manager tag, a security manager tag, a sustainability manager tag, etc. In one embodiment, the role tags are assigned based on the correlation between the credential and building operation role tags. The credential of the building operation personnel may have a strong correlation to the credential associated with multiple role tags. In this regard, the building operation personnel may be assigned to more than one role tag. For example, a building operation personnel that is responsible for monitoring a building lighting system may be assigned to both a building management role tag and a sustainability management role tag, as the building lighting system may have various controls to be managed.

In another embodiment of step 706, the building operation personnel is assigned a role by the AI agent 570. For example, the AI agent 570 may assign a building operation personnel as a building manager, a security manager, or a sustainability manager. In some embodiments, the credential of the building operation personnel may have a strong correlation to the credential associated with multiple roles. In this regard, the building operation personnel may be assigned more than one role by the AI agent 570. For example, a building operation personnel that is responsible for monitoring a building lighting system may be assigned to both a building management role and a sustainability management role, as the building lighting system may have various controls to be managed.

In step 708, the building data platform 100 may categorize the building operation personnel based on one or more determined roles. In some embodiments, the building data platform 100 may categorize the personnel based on the role tags in which they were assigned. For example, the building operation personnel may be assigned to a security manager role tag based on the correlation determined in step 704. In response, the building data platform may further categorize the personnel into a broader security information database which may be accessed by other personnel with role tags related to building information, such as personnel with the assigned role tags including a security guard tag and security engineer tag, to name a few.

In another embodiment, the building operation personnel by be categorized by the AI agent 570. In this regard, the AI agent 570 may categorize the building operation personnel based on the role assigned in step 706. In some embodiments, the AI agent 570 may categorize building operation personnel into a wider category in which personnel of multiple roles are grouped into. For example, a building operation personnel may be assigned to a role of security manager. The security manager may then be granted access to a broader information security database. The broader information security database may be accessed by other personnel related to building security, such as personnel with the assigned roles of security guard and security engineer, to name a few.

In step 710, the building data platform 100 may store the one or more determined roles in a first separate data structure. The building data platform 100 may also store the one or more categories of the determined roles in a second separate data structure relating to building operation categories. In one embodiment, the first separate data structure may be related to determined role tags. The second separate data structure may then be related to categories of role tags. For example, the building data platform may assign a building operation personnel with an energy management tag and further categorize the personnel into an energy category. In response, the building data platform 100 may store the personnel's energy management tag in the first separate data structure and store the personnel's energy category in the second separate data structure.

In another embodiment of step 710, the one or more determined roles may be stored by the AI agent 570. In this regard, the AI agent 570 may store the determined role in a separate data structure. The determined role may then be accessed by the twin manager 108 upon receiving building information. The determined role is used to execute the process 600 shown in FIG. 6. For example, the role of security manager assigned to the building operation personnel in step 708 may be stored by the twin manager 108. Upon receiving new security information, the twin manager 108 can receive the stored role of security manager to allow the AI agent 570 to determine a correlation between the new security information and the security manager. The AI agent 570 may then grant access of the security information to the security manager. In some embodiments, the AI agent 570 may also store one or more categories of the determined role in a separate data structure.

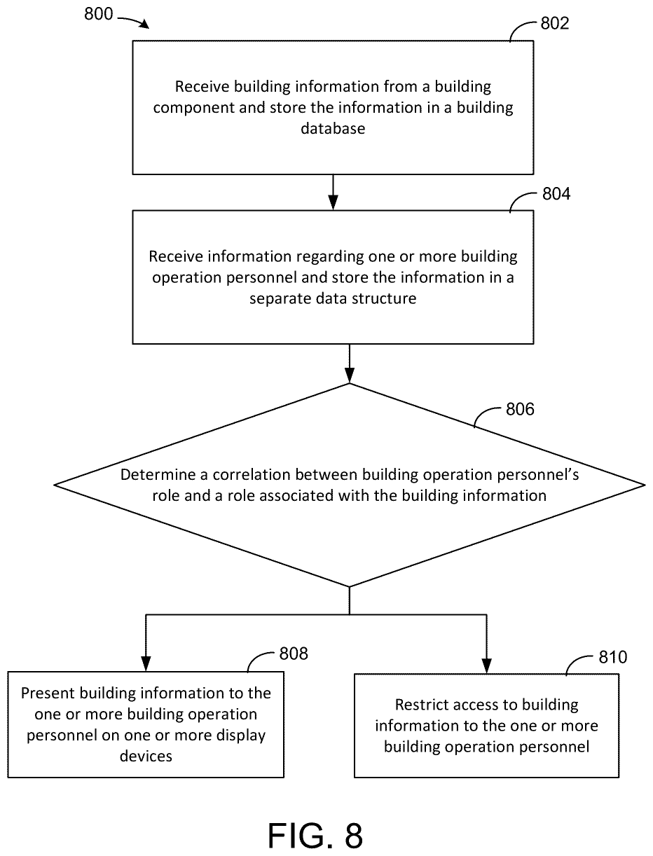

Referring now to FIG. 8, a process 800 for receiving building information and distributing the building information accordingly to the building operation personnel with the proper role. The process 800 can be performed by the system and/or components of the system. The process 800 can be performed by the system and/or components of the system. The process 800 can be performed by a building operation personnel data platform. Furthermore, the process 800 can be performed by any computing device described herein.

In step 802, the building data platform 100 may receive building information from a building component and store the information, or a link to the information, in a building database. In one embodiment, the building information is stored in a cloud database. In another embodiment, the building information is stored in a building data platform. In another embodiment of step 802, the twin manager 108 may receive building information from a building component and stores the information, or a link to the information, in the graph 529. In some embodiments, the building information can be received from physical devices, e.g., from activation of a building entrance. The physical device can store the received information in the graph by relating a node storing the information to a node representing the physical device. Upon receiving the building information, the twin manager 108 may execute the AI agent 570 to further categorize the building information into predetermined categories and store the categorized building information. In some embodiments, predetermined categories are set based on the operations performed in the building. For example, the predetermined categories for building information of a particular building may include building management, security, energy, software, sustainability, etc. For example, the twin manager 108 may receive information regarding an indication that a light bulb needs replacement. The AI agent 570 may then categorize the information into a category that relates to light bulb replacement, such as a building management category, and then store the categorized building information.

In step 804, the building data platform 100 may receive information regarding one or more building operation personnel. In one embodiment, the building operation personnel information is retrieved from the data structure of role tags described in step 710 of process 700, as shown in FIG. 7. In another embodiment of step 804, the information is received by the twin manager 108. In this regard, the twin manager 108 may receive information regarding one or more building operation personnel. In this exemplary embodiment, the building operation personnel information is retrieved from the data structure of determined roles described in step 710 of process 700, as shown in FIG. 7. In some embodiments, the building operation personnel information received by the twin manager 108 may relate to building operation personnel that have manually requested access to the building information received in step 802. For example, the twin manager 108 may receive information relating to a door that has been opened without authorization. The twin manager 108 may then receive building operation personnel information related to a building operation personnel that has attempted to access data relating to unauthorized building entries. In some embodiments, building operation personnel information received by the twin manager 108 may regard any of the building operation personnel that have a stored history of receiving similar information. For example, the twin manager 108 may receive building information relating to a detection of malware on a building network and categorize the building information as software security information. The twin manager 108 may then receive building operation personnel information relating to building operation personnel that have previously accessed software security information. In some embodiments, the twin manager 108 may receive information relating to all building operation personnel assigned to the building in which the building information from 802 is received, and a comparison is then determined by the AI agent 570 for each personnel.

In step 806, the building data platform 100 determines a comparison between the building information received in step 802 to the building operation personnel information received in step 804. In one embodiment, a correlation is determined between a tag assigned to the building information and a role tag assigned to the building operation personnel. Both the building information tag and the role tag may be contained in their respective data structures and have a corresponding assigned category. The role tag associated with the building operation personnel may be the same role that was assigned in step 706 of process 700, as shown in FIG. 7. After the correlation is determined, the building data platform 100 may determine whether the category associated with the building information tag is the same as the category of the role tag.

In step 806, the AI agent 570 determines a comparison between the building information received in step 802 to the building operation personnel information received in step 804. In some embodiments, the AI agent 570 compares categorized building information from step 802 to categorized building information from step 804 and determine a correlation. Both the building information and the building operation personnel information may be contained in their respective data structures and have a corresponding assigned category. After the comparison, the AI agent 570 may determine whether the category associated with the building information is the same as the category of the role assigned with the building operation personnel. In some embodiments, the role associated with the building operation personnel is the same role that was assigned in step 706 of process 700, as shown in FIG. 7.

In step 808, the building data platform 100 may present the building information to the building operation personnel on one or more display devices, in response to determining a correlation. In one embodiment, the building information is displayed in response to the building data platform determining a correlation between the building information tag assigned to the building information and the building operation personnel role tag assigned to the personnel. In some embodiments, the building data platform 100 may only display the information if the correlation value exceeds a required correlation threshold.

In another embodiment of step 808, the AI agent 570 presents the building information. In this regard, the AI agent 570 presents the information to the one or more building operation personnel on one or more display devices. In some embodiments, the display devices are augmented reality devices, such as personal augmented reality headsets. In some embodiments, the display devices are monitors, such as those in a command center. In some embodiments, the information will be stored, and the building operation personnel may access it via the display devices at any time. In some embodiments, the information will automatically display on the screen to notify the building operation personnel of the information. For example, the twin manager 108 may receive security information that a door has been opened during a time in which entry through the door is restricted. In response, the AI agent 570 may automatically present the security information to a security guard.

In step 810, the building data platform 100 may restrict access to the building information to the one or more building operation personnel considered in step 804, in response to determining a correlation. In some embodiments, the building data platform 100 may only restrict access to the building information if the correlation value does not meet or exceed a required correlation threshold. In one embodiment, the building information is restricted in response to determining a correlation between the building information tag assigned to the building information and the building operation personnel role tag assigned to the personnel.

In another embodiment of step 810, the AI agent 570 restricts access to the building information from the building operation personnel. In this regard, the AI agent 570 may restrict access to the information to the one or more building operation personnel considered in step 804. For example, the twin manager 108 may receive security information that a door has been opened during a time in which entry through the door is restricted. In response to receiving the security information, the AI agent 570 may ensure that all building operation personnel whose roles are not in the security category do not receive access to the security information. In some embodiments, the building operation personnel that are restricted access will be redirected to a global interface where they can navigate to information that they may have access to. In some embodiments, the building operation personnel that are restricted access will see a user interface of a similar layout to one with access, but the restricted information will be hidden in locations where it would normally be shown. In some embodiments, the user interface of the building operation personnel will remain the same, without any indication to the building operation personnel that restricted information has been received by the twin manager 108.

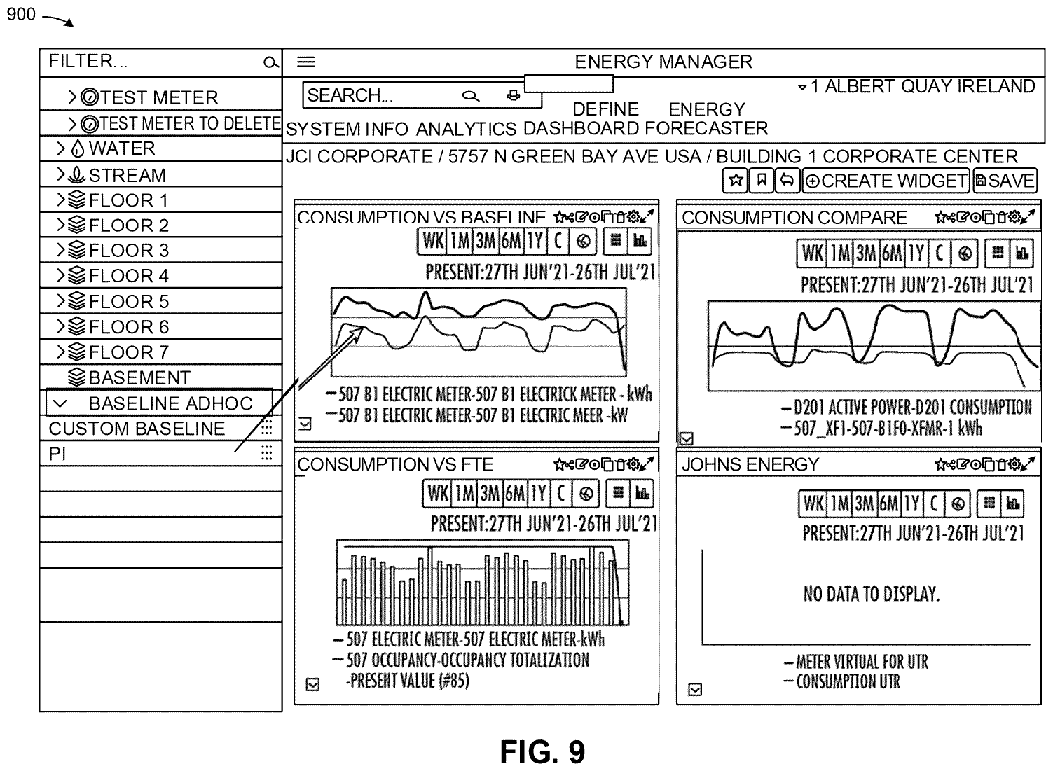

As described in processes 600 and 800, the building information is displayed to the correct building operation personnel on display device(s). The exemplary embodiment shown in FIGS. 9-13 show the building information being presented as a computer monitor being the display device, e.g., in a typical command center. In some embodiments, the AI agent 570 undergoes a machine learning process to determine relevant information for the role and presents the information to the device. In this embodiment, the user interface is presented as a custom dashboard.

Referring now to FIG. 9, a snapshot of a custom dashboard 900 for a building operation personnel with the assigned role of energy manager, according to some embodiments. The snapshot of the custom dashboard 900 provides an example of the personalized view on the display device that displays only information that is associated with the role of energy manager. In some embodiments, the custom dashboard 900 stores past data for certain information, so as to provide an overview of how the data has changed over a given time period. In some embodiments, the information presented to the energy manager is further organized into data for each floor of the building being managed. The information displayed on the custom dashboard 900 for the energy manager is determined with a machine learning process and includes relevant information for the energy manager. For example, the custom dashboard 900 may display energy consumption in the building over a given time period (e.g., one week, one month, three months, six months, or one year), and compare the energy consumption to a baseline consumption level.

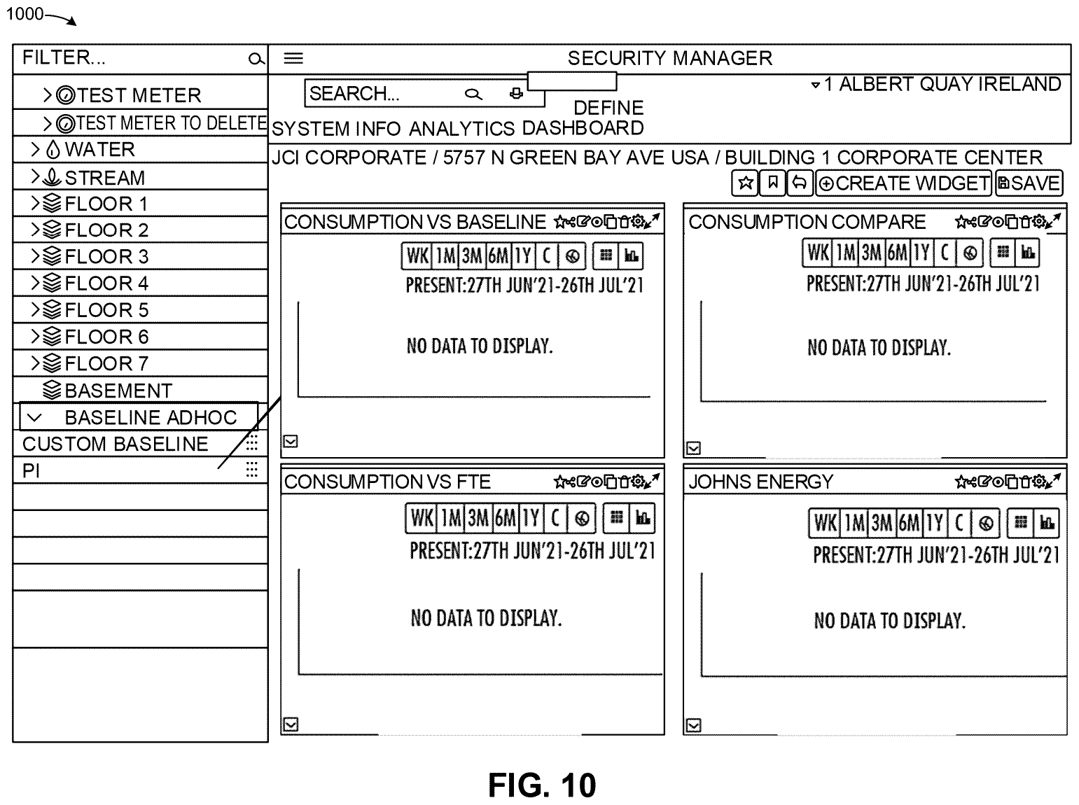

Referring now to FIG. 10, a snapshot of a custom dashboard 1000 for a building operation personnel with the assigned role of security manager, according to some embodiments. In the exemplary embodiment, the snapshot of the custom dashboard 1000 demonstrates a possible custom dashboard interface in the event that the building operation personnel does not match the role associated with the building information. In some embodiments, the custom dashboard 1000 has the same overall layout as a custom dashboard 900 with proper role requirements, but the private information is simply missing from the dashboard. In some embodiments, in place of the building information the custom dashboard displays a text box reading “NO DATA TO DISPLAY.” Similar to FIG. 9, the custom dashboard 1000 may include a section dedicated to energy consumption in the building over a given time period and compared to a baseline consumption level, but there is no data displayed in the section.

Referring now to FIG. 11, a snapshot of a custom dashboard 1100 for a building operation personnel with the assigned role of building manager, according to some embodiments. The snapshot of the custom dashboard 1100 provides an example of the personalized view on the display device that displays only information that is associated with the role of building manager. In some embodiments, the custom dashboard 1100 stores past data for certain information, so as to provide an overview of how the data has changed over a given time period. In some embodiments, the information presented to the building manager is further organized into data for each floor of the building being managed. The information displayed on the custom dashboard 1100 for the building manager is determined with a machine learning process and includes relevant information for the building manager. For example, the custom dashboard 1100 may display the air quality index on each floor. The air quality index may be displayed on a graph and compared to a recommended baseline air quality index. In some embodiments, the building manager has the ability to change the settings of the air quality systems in the buildings based on the information presented on the custom dashboard. In some embodiments, the custom dashboard 1100 for the building manager may display the occupancy of each floor in the building. In some embodiments, the custom dashboard 1100 for the building manager may display the status of building components, including an indication of any maintenance faults.

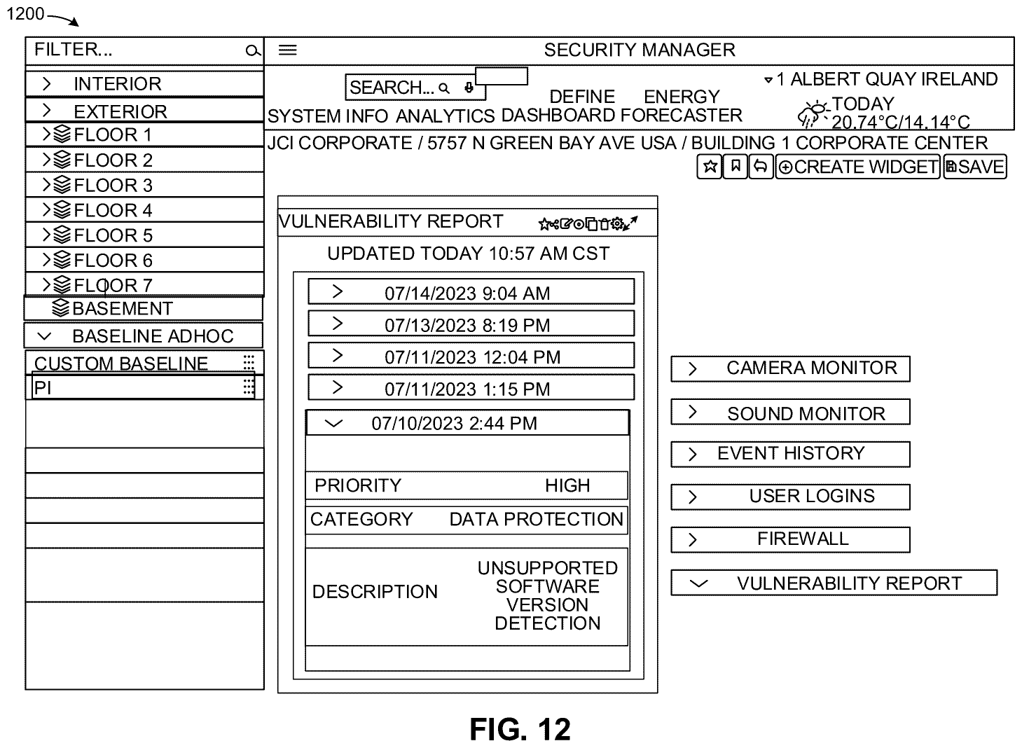

Referring now to FIG. 12, a snapshot of a custom dashboard 1200 for a building operation personnel with the assigned role of a security manager, according to some embodiments. The snapshot of the custom dashboard 1200 provides an example of the personalized view on the display device that displays only information that is associated with the role of the security manager. The information displayed on the custom dashboard 1200 for the security manager may be determined with a machine learning process and includes relevant information for the building manager. In some embodiments, the custom dashboard 1200 stores past data for certain information, so as to provide an overview of how the data has changed over a given time period. In some embodiments, the information presented to the energy manager is further organized into data for each floor of the building being managed. In some embodiments, the security manager is limited to viewing security information relating to the network of the building. For example, the security manager might have access to a vulnerability report for the network, a firewall for the network, and user logins to building operations databases. In some embodiments, the security manager is limited to viewing security information relating to the physical security of the building. For example, the security manager may have access to footage from security cameras throughout the building, recordings from sound sensors and monitors throughout the building, or history logs of events which may include indications of persons entering and leaving the building.

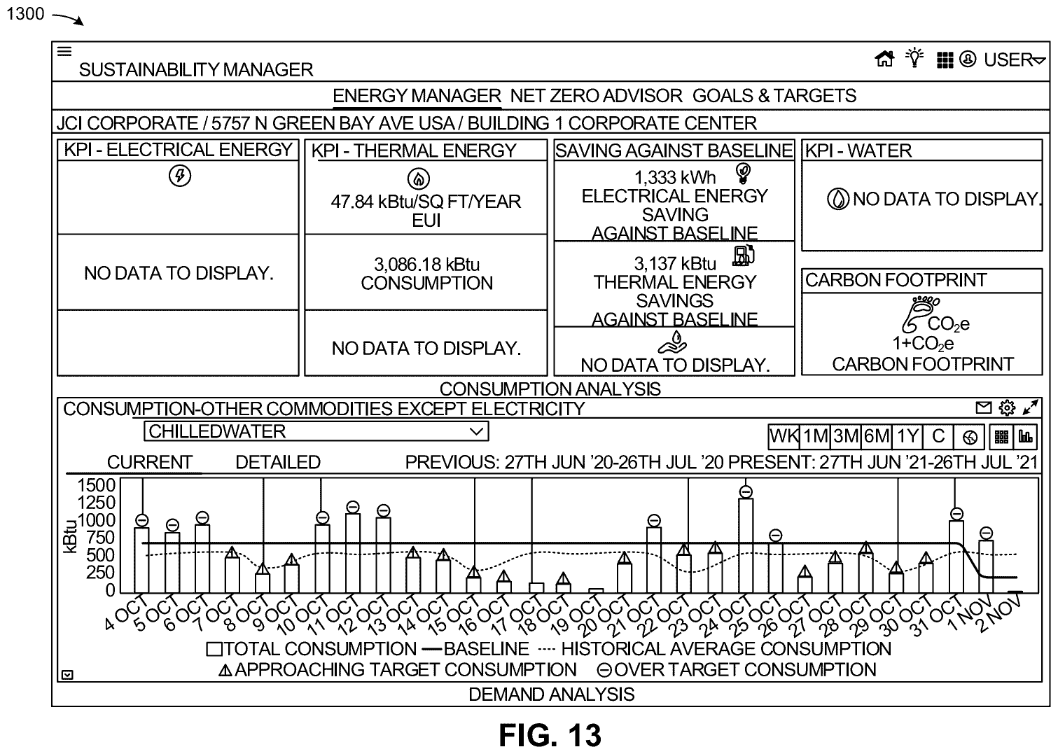

Referring now to FIG. 13, a snapshot of a custom dashboard 1300 for a sustainability manager. The snapshot of the custom dashboard 1300 provides an example of the personalized view on the display device that displays only information that is associated with the role of the sustainability manager. The information displayed on the custom dashboard 1300 for the sustainability manager may be determined with a machine learning process and includes relevant information for the sustainability manager. In some embodiments, the custom dashboard 1300 stores past data for certain information, so as to provide an overview of how the data has changed over a given time period. For example, the custom dashboard 1300 for the sustainability manager may display a consumption analysis, in which the consumption of multiple resources can be monitored over a given time period. The consumption analysis may analyze consumption of resources such as chilled water, electrical energy, or thermal energy, to name a few. In some embodiments, the custom dashboard 1300 displays the carbon footprint of the selected section of the building. In some embodiments, the custom dashboard displays energy savings of the building compared to a baseline level of energy savings.

The interfaces described above may also include selectable options to alter operation of building equipment so as to increase or decrease resource consumption. For example, a user may be able to select an option to implement a resource savings control strategy (e.g., relaxing temperature constraints, turning off certain equipment, changing temperature setpoints, changing other settings), etc. Building equipment may operate differently in response to selection of such an option, for example, due to different control settings selected by a processing circuit or other circuitry in response to user input. In another example, a security guard may be able to open a door through their device. In another example, a building manager may be able to change the settings on an air quality machine through their custom dashboard. The teachings herein thereby result in physical changes in equipment operation driven by the features of the various interfaces, processes, systems, etc. disclosed herein.

The interfaces described above may be presented on various display devices. In some embodiments, the interface is presented on a desktop monitor. In some embodiments, the interface is presented using a mobile application. In some embodiments, the information that is presented on the custom dashboards may be reconfigured and displayed through an augmented reality headset. For example, a security manager may be presented with custom dashboard 1000 on a monitor. In the event of an unauthorized entry, the custom dashboard 1000 may include live camera footage of a location in which the unauthorized entry occurred. The security manager may then be able to configure the camera footage on the custom dashboard 1000 to be displayed on an augmented reality headset. In this regard, the security manager may maintain access to the live footage when the monitor with the custom dashboard 1000 is not in view. In some embodiments, the display device is a virtual video wall or virtual screen presented using augmented reality.

In some embodiments, the processes 600 and 800 are location based. When new building information is received, the processes 600 and 800 are limited to the building operation personnel that are in a close proximity to the event that has occurred.

In some embodiments, the twin manager 108 will automatically trigger a building operation personnel's display device to present new building information. For example, if a security manager is in proximity to a door that has been opened without authorization, the device being operated by the security manager will automatically alert the security manager of the event. In some embodiments, the twin manager 108 will receive the time in which the door has been opened and the AI agent 570 may store it in the data structure associated with the event. In some embodiments, the AI agent 570 will alert the security manager by displaying a message explaining the location of the event. In some embodiments, the AI agent 570 will display a floor plan of the building and highlight where the event occurred, so as to easily direct the building operation personnel to the location of the event. In some embodiments, if the security manager is using an AR or VR headset, the AI agent 570 will distinguish where the event happened on the digital view of the building that is being viewed through the headset (e.g., displaying an opened door in a different color). In some embodiments, the AI agent 570 will annotate any doors in the building that have been opened after a security alarm has been activated.

In some embodiments, the display device is a mobile device. In this embodiment, building operation personnel access the building information through a mobile application. In some embodiments, the building operation personnel will receive a notification (e.g., a phone call or a text message) that an event has occurred. In some embodiments, the mobile device is paired to an AR headset, and the AR headset will receive the information presented on the mobile application to show the building operation personnel where the event has occurred in the physical building.

In some embodiments, the display device used by an individual building operation personnel can relay information back to a global command center. For example, a security manager may wear an AR headset with a camera when in the location of an event. The camera can record footage in real time and relay the footage to a monitor in the command center.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed:

1. A building system of a building, the building system comprising one or more memory devices storing instructions thereon that, when executed by one or more processors, cause the one or more processors to:
receive building information associated with one or more entities of the building, the one or more entities comprising at least one of locations, events, assets, or people associated with the building;
categorize the building information into a first set of the building information and a second set of the building information different from the first set, the first and second sets of the building information extracted and/or derived from the building information; and
generate a distributed command center for monitoring and/or responding to events in or associated with the building, the distributed command center comprising a plurality of command center interfaces to be provided to a plurality of users on a plurality of devices, the plurality of devices comprising a first device of a first user and a second device of a second user, generating the distributed command center comprising:
generating a first command center interface comprising the first set of building information to be provided to the first user based on at least one of a first role or a first set of permissions associated with the first user;
generating a second command center interface comprising the second set of building information to be provided to the second user based on at least one of a second role or a second set of permissions associated with the second user; and
transmitting the first command center interface to the first device of the first user and the second command center interface to the second device of the second user.

2. The building system of claim 1, wherein the instructions when executed by the one or more processors, cause the one or more processors to:
receive credentials of the plurality of users;
compare the credentials to a stored building operation personnel database;
determine a role of the plurality of users based on a comparison between the credentials and the stored building operation personnel database;
categorize the plurality of users based on the determined role received from the stored building operation personnel database;
determine a correlation between the categorized building information and the categorized plurality of users by comparing the description tags and the determined role; and
present the building information to the plurality of users based on the determined correlation.

3. The building system of claim 1, wherein the instructions when executed by the one or more processors, cause the one or more processors to:
receive information regarding the plurality of users;
receive a role of the plurality of users from a stored building operation personnel database;
determine if the role of the plurality of users is the same as an associated role associated with the building information; and
(i) present the building information to a user of the plurality of users on the one or more display devices if the role of the user is the same as the associated role, or (ii) restrict access to the building information to the user if the role of the user is not the same as the associated role.

4. The building system of claim 1, wherein the one or more display devices are augmented reality devices or virtual reality devices.

5. The building system of claim 1, wherein the building information is presented as a graphical user interface.

6. The building system of claim 5, wherein the graphical user interface further comprises a user-selectable option to adjust an operation of building equipment based on the building information presented.

7. The building system of claim 1, wherein the one or more display devices are implemented within a virtual or physical command center.

8. The building system of claim 1, wherein the instructions further cause the processor to store the received building information in a digital twin graph.

9. The building system of claim 8, wherein an artificial intelligence agent executes a machine learning algorithm based on the building information stored in the digital twin graph to categorize the building information.

10. A method comprising:
receiving building information associated with one or more entities of a building, the one or more entities comprising at least one of locations, events, assets, or people associated with the building;
categorizing the building information into a first set of the building information and a second set of the building information different from the first set, the first and second sets of the building information extracted and/or derived from the building information; and
generating a distributed command center for monitoring and/or responding to events in or associated with the building, the distributed command center comprising a plurality of command center interfaces to be provided to a plurality of users on a plurality of devices, the plurality of devices comprising a first device of a first user and a second device of a second user, generating the distributed command center comprising:
generating a first command center interface comprising the first set of building information to be provided to the first user based on at least one of a first role or a first set of permissions associated with the first user;
generating a second command center interface comprising the second set of building information to be provided to the second user based on at least one of a second role or a second set of permissions associated with the second user; and
transmitting the first command center interface to the first device of the first user and the second command center interface to the second device of the second user.

11. The method of claim 10, the method further comprising:
receiving credentials of the plurality of users;
comparing the credentials to a stored building operation personnel database;
determining a role of the plurality of users based on a comparison between the credentials and the stored building operation personnel database;
categorizing the plurality of users based on the determined role received from the stored building operation personnel database;
determining a correlation between the categorized building information and the categorized plurality of users by comparing the description tags and the determined role; and
presenting the building information to the plurality of users based on the determined correlation.

12. The method of claim 10, further comprising:
receiving information regarding the plurality of users;
receiving a role of the plurality of users from a stored building operation personnel database;
determining if the role of the plurality of users is the same as an associated role associated with the building information; and
(i) presenting the building information to a user of the plurality of users on the one or more display devices if the role of the user is the same as the associated role, or (ii) restricting access to the building information to the user if the role of the user is not the same as the associated role.

13. The method of claim 10, wherein the one or more display devices are augmented reality devices or virtual reality devices.

14. The method of claim 10, wherein the building information is presented as a graphical user interface.

15. The method of claim 14, wherein the graphical user interface further comprises a user-selectable option to adjust an operation of building equipment based on the building information presented.

16. The method of claim 10, wherein the one or more display devices are implemented within a virtual or physical command center.

17. The building system of claim 10, wherein the instructions further cause the processor to store the received building information in a digital twin graph.

18. The method of claim 17, wherein an artificial intelligence agent executes a machine learning algorithm based on the building information stored in the digital twin graph to categorize the building information.

19. A non-transitory computer readable medium storing instructions thereon that, when executed by one or more processors, cause the one or more processors to:
receive building information associated with one or more entities of the building, the one or more entities comprising at least one of locations, events, assets, or people associated with the building;
categorize the building information into a first set of the building information and a second set of the building information different from the first set, the first and second sets of the building information extracted and/or derived from the building information; and
generate a distributed command center for monitoring and/or responding to events in or associated with the building, the distributed command center comprising a plurality of command center interfaces to be provided to a plurality of users on a plurality of devices, the plurality of devices comprising a first device of a first user and a second device of a second user, generating the distributed command center comprising:
generating a first command center interface comprising the first set of building information to be provided to the first user based on at least one of a first role or a first set of permissions associated with the first user;
generating a second command center interface comprising the second set of building information to be provided to the second user based on at least one of a second role or a second set of permissions associated with the second user; and
transmitting the first command center interface to the first device of the first user and the second command center interface to the second device of the second user.

20. The non-transitory computer readable medium of claim 19, wherein the instructions when executed by the one or more processors, cause the one or more processors to:
receive credentials of the plurality of users;
compare the credentials to a stored building operation personnel database;
determine a role of the plurality of users based on a comparison between the credentials and the stored building operation personnel database;
categorize the plurality of users based on the determined role received from the stored building operation personnel database;
determine a correlation between the categorized building information and the categorized plurality of users by comparing the description tags and the determined role; and
present the building information to the plurality of users based on the determined correlation.
